(19) United States
(12) Patent Application Publication
(10) Pub. No.: US 2023/0080679 A1
(43) Pub. Date: Mar. 16, 2023

(54) DISTINGUISHING BETWEEN AGGRESSIVE AND NON-AGGRESSIVE DEVICES

(71) Applicant: AT&T Intellectual Property I, L.P., Atlanta, GA (US)

(72) Inventors: Yaron Koral, Cherry Hill, NJ (US); Matti Hiltunen, Morristown, NJ (US)

(21) Appl. No.: 17/475,069

(22) Filed: Sep. 14, 2021

(51) Int. Cl. H04W 12/75; H04W 76/18; H04W 8/18; H04W 8/22; H04W 12/61; H04W 12/72; H04W 12/037

(52) U.S. Cl. CPC H04W 12/75; H04W 76/18; H04W 8/18; H04W 8/22; H04W 12/61; H04W 12/72; H04W 12/037

(57) ABSTRACT

Aggressive behavior by aggressive devices against a radio access network (RAN) can be detected and mitigated, while allowing benign devices to attach to a network. A security management component (SMC) can analyze temporary device identifier data (TDID) associated with RAN and an attach request and associated information, comprising a temporary device identifier (TDI), received from a device. Based on the analysis, SMC can reject the attach request if TDI is not in TDID and store TDI in TDID, or can accept the attach request if TDI is in TDID and a threshold amount of time since a previous attach request associated with TDI is determined to be satisfied. SMC can continue to monitor attach requests, and if the device detaches from the network and sends another attach request associated with TDI to quickly reattach to network, SMC can reject the attach request and identify the device as aggressive.

### TECHNICAL FIELD

This disclosure relates generally to electronic communications, e.g., to distinguishing between aggressive and non-aggressive devices.

### BACKGROUND

Communication devices can communicate data to other communication devices via a communication network. For example, a wireless device (e.g., mobile, cell, or smart phone; or electronic tablet or pad) can connect to and communicate with a wireless communication network (e.g., core network), via a base station associated with the wireless communication network, to communicate with another communication device connected to the wireless communication network or to another communication network (e.g., Internet Protocol (IP)-based network, such as the Internet) associated with (e.g., communicatively connected to) the wireless communication network. The wireless device can, for instance, communicate information to a base station and associated wireless communication network (e.g., core network) via an uplink and can receive information from the base station (and associated wireless communication network) via a downlink.

The above-described description is merely intended to provide a contextual overview regarding electronic communications, and is not intended to be exhaustive.

### BRIEF DESCRIPTION OF THE DRAWINGS

FIG. 1 illustrates a block diagram of an example system that can distinguish between benign communication devices and aggressive communication devices to facilitate mitigating aggressive and/or malicious events by aggressive communication devices against a radio access network (RAN) of a communication network and can manage connection of communication devices to the RAN, in accordance with various aspects and embodiments of the disclosed subject matter.

FIG. 2 depicts a block diagram of an example attach request processing flow relating to a communication device that can be attempting to attach, register, or connect, to or with the RAN and can be determined to be acting in a benign manner by a security management component (SMC), in accordance with various aspects and embodiments of the disclosed subject matter.

FIG. 3 illustrates a block diagram of an example attach request processing flow relating to a communication device that can be attempting to attach, register, or connect, to or with the RAN and can be determined to be acting in an undesirably aggressive manner by the SMC, in accordance with various aspects and embodiments of the disclosed subject matter.

FIG. 4 depicts a block diagram of another example attach request processing flow relating to a communication device that can be attempting to attach, register, or connect, to or with the RAN and can be determined to be acting in an undesirably aggressive manner by the SMC, in accordance with various aspects and embodiments of the disclosed subject matter.

FIG. 5 illustrates a block diagram of yet another example attach request processing flow relating to a communication device that can be attempting to attach, register, or connect, to or with the RAN and can be determined to be acting in an undesirably aggressive manner by the SMC, in accordance with various aspects and embodiments of the disclosed subject matter.

FIG. 6 depicts a diagram of an example system comprising a RAN to which communication devices, including IoT devices, are attempting to connect or are already connected, wherein the RAN comprises an SMC that can detect and mitigate aggressive and/or malicious events against the RAN by aggressive and/or malicious communication devices and can manage attachment, registration, or connection of communication devices to the RAN or associated communication network, in accordance with various aspects and embodiments of the disclosed subject matter.

FIG. 7 depicts a block diagram of an example SMC, in accordance with various aspects and embodiments of the disclosed subject matter.

FIG. 8 depicts a block diagram of example communication device, in accordance with various aspects and embodiments of the disclosed subject matter.

FIG. 9 illustrates a block diagram of an example access point, in accordance with various aspects and embodiments of the disclosed subject matter.

FIG. 10 illustrates a flow chart of an example method that can determine whether to accept an attach request associated with a temporary device identifier associated with a communication device in connection with determining whether the communication device is an aggressive communication device, to facilitate mitigating aggressive and/or malicious events against a RAN and/or associated communication network, in accordance with various aspects and embodiments of the disclosed subject matter.

FIG. 11 depicts a flow chart of an example method that can detect, determine, and/or distinguish between aggressive communication devices and benign communication devices to facilitate mitigating aggressive and/or malicious events by aggressive communication devices against a RAN and/or associated communication network, in accordance with various aspects and embodiments of the disclosed subject matter.

FIG. 12 illustrates a flow chart of an example method that can detect, determine, and/or distinguish between aggressive communication devices and benign communication devices, including aggressive communication devices that undesirably (e.g., aggressively) attempt to attach, detach, and reattach to a communication network to facilitate mitigating aggressive and/or malicious events by aggressive communication devices against a RAN and/or associated communication network, in accordance with various aspects and embodiments of the disclosed subject matter.

FIG. 13 presents a flow chart of another portion of the example method that can apportion or allocate attach requests associated with communication devices to facilitate performing an aggressive device detection analysis on a first portion of the attach requests by the SMC while forwarding a second portion of the attach requests to the packet core component of the core network without performing an aggressive device detection analysis on the second portion of the attach requests, in accordance with various aspects and embodiments of the disclosed subject matter.

FIG. 14 is a schematic block diagram illustrating a suitable computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Discussed herein are various aspects that relate to distinguishing between aggressive and non-aggressive (e.g., benign) devices to facilitate mitigating aggressive signaling (e.g., excessive or malicious signaling) and/or malicious events, such as, for example, distributed denial of service (DDoS) attacks (also referred to herein as signaling storms), against a communication network (e.g., wireless communication network). The disclosed subject matter can employ desirable (e.g., more efficient, enhanced, or optimized) aggressive device detection techniques, applications, and/or mechanisms that can enhance (e.g., increase, improve, or optimize) security and robustness of a wireless communication network, such as, for example, a cellular communication network. The disclosed subject matter can provide benefits to mobile carriers and other organizations that operate mobile communication networks, including private mobile communication networks, such as, for example, government entities, defense contractors, enterprises, and/or other entities that have local mobile and/or cellular communication networks and systems (e.g., multi-access edge computing (MEC)). Applying the desirable (e.g., more efficient, enhanced, or optimized) aggressive device detection techniques, applications, and/or mechanisms can desirably reduce redundant or otherwise undesirable (e.g., unnecessary) network equipment costs that are usually incurred to absorb and manage signaling storm attacks by aggressive and/or malicious communication devices. The disclosed subject matter, by applying the desirable aggressive device detection techniques, applications, and/or mechanisms, can reduce or minimize the collateral damage that may be applied to benign communication devices (e.g., disconnecting or denial of access or service to benign (e.g., non-aggressive) communication devices), as compared to existing techniques that can incur an undesirable level of collateral damage against benign communication devices. The disclosed subject matter can be relevant to and utilized by existing communication networks, and can be even more desirable (e.g., suitable) for 5G and other next generation communication networks and communication technologies.

The various aspects described herein can relate to new radio, which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, a UMTS implementation, and/or an LTE implementation as the techniques can also be applied in 2G, 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies. Further, the various aspects can be utilized with any Radio Access Technology (RAT) or multi-RAT system where the mobile device operates using multiple carriers (e.g., LTE Frequency Division Duplexing (FDD)/Time-Division Duplexing (TDD), Wideband Code Division Multiplexing Access (WCMDA)/HSPA, Global System for Mobile Communications (GSM)/GSM EDGE Radio Access Network (GERAN), Wi Fi, Wireless Local Area Network (WLAN), WiMax, CDMA2000, and so on).

As used herein, “5G” can also be referred to as New Radio (NR) access. Accordingly, systems, methods, and/or machine-readable storage media for reducing interference on reference signals from other co-channel reference signals, and improving the channel estimation performance for CSI estimation and data detection, in 5G systems, and other next generation systems, can be desired. As used herein, one or more aspects of a 5G network can comprise, but is not limited to, data rates of several tens of megabits per second (Mbps) supported for tens of thousands of users; at least one gigabit per second (Gbps) that can be offered simultaneously to tens of users (e.g., tens of workers on the same office floor); several hundreds of thousands of simultaneous connections supported for massive sensor deployments; spectral efficiency that can be significantly enhanced compared to 4G; improvement in coverage relative to 4G; signaling efficiency that can be enhanced compared to 4G; and/or latency that can be significantly reduced compared to LTE.

Multiple Input, Multiple Output (MIMO) technology can be employed in communication networks, wherein MIMO technology can be an advanced antenna technique utilized to improve spectral efficiency and, thereby, boost overall system capacity. Spectral efficiency (also referred to as spectrum efficiency or bandwidth efficiency) refers to an information rate that can be transmitted over a given bandwidth in a communication system.

For MIMO, a notation (M×N) can be utilized to represent the MIMO configuration in terms of a number of transmit antennas (M) and a number of receive antennas (N) on one end of the transmission system. Examples of MIMO configurations used for various technologies can include: (2×1), (1×2), (2×2), (4×2), (8×2) and (2×4), (4×4), (8×4). The configurations represented by (2×1) and (1×2) can be special cases of MIMO known as transmit and receive diversity.

In some cases, MIMO systems can significantly increase the data carrying capacity of wireless communications systems. Further, MIMO can be used for achieving diversity gain, which refers to an increase in signal-to-interference ratio due to a diversity scheme and, thus, can represent how much the transmission power can be reduced when the diversity scheme is introduced, without a corresponding performance loss. MIMO also can be used to achieve spatial multiplexing gain, which can be realized when a communications system is transmitting different streams of data from the same radio resource in separate spatial dimensions (e.g., data is sent/received over multiple channels, linked to different pilot frequencies, over multiple antennas). Spatial multiplexing gain can result in capacity gain without the need for additional power or bandwidth. In addition, MIMO can be utilized to realize beamforming gain. Due to the benefits achieved, MIMO can be an integral part of the third generation wireless system and the fourth generation wireless system. In addition, 5G systems also will employ massive MIMO systems (e.g., hundreds of antennas at the transmitter side and receiver side). Typically, with a (Nₜ, Nᵣ), where Nₜ denotes the number of transmit antennas and Nᵣ denotes the number of receive antennas, the peak data rate can multiply with a factor of Nₜ over single antenna systems in a rich scattering environment.

Communication devices can communicate information (e.g., voice and/or data traffic) to other communication devices via a communication network, which can comprise a core network that can operate to enable wireless communication between communication devices. For example, a wireless communication device (e.g., mobile, cell, or smart phone; electronic tablet or pad; computer; or other communication device) can connect to and communicate with a wireless communication network (e.g., core network) to communicate with another communication device connected to the wireless communication network or to another communication network (e.g., Internet Protocol (IP)-based network, such as the Internet) associated with (e.g., communicatively connected to) the wireless communication network.

Communication devices can operate and communicate via wireless or wireline communication connections (e.g., communication links or channels) in a communication network to perform desired transfers of data (e.g., voice and/or data communications), utilize services, engage in transactions or other interactions, and/or perform other operations. In addition to wireless phones, electronic pads or tablets, and computers being used and connected to the communication network, increasingly Internet of Things (IoT) devices are being used and connected to the communication network. The number of IoT devices being employed is expected to increase exponentially into the tens of billions of IoT devices, which has been referred to as massive IoT. Massive IoT can be one of the key service drivers for 5G and other next generation communication networks.

IoT devices often can aim at lower power consumption and/or lower price at the expense of having undesirable (e.g., degraded or insufficient) security features. For instance, many IoT devices cannot host anti-virus capabilities by design. Furthermore, the relatively low entry barrier to building and selling new IoT device types can introduce undesirable (e.g., sketchy or insufficiently knowledgeable) vendors that can employ device implementations that can be vulnerable to malware and malicious actors. Many IoT devices can have security vulnerabilities, such as Zero Day vulnerabilities, such as security holes in the software of the IoT devices that can be unknown to the vendor and can be exploited by malicious users (e.g., hackers or criminals). Malicious users can exploit such vulnerabilities in IoT devices, for example, to create botnet armies by infecting IoT devices with stealthy malware (e.g., by surreptitiously installing stealthy malware on IoT devices). This security threat can be expected to increase in magnitude due to the “massive” factor in massive IoT.

One of the main goals of these botnet armies of infected IoT devices can be to disrupt communication services, including mission critical 5G and other next generation services, of a communication network by means of DDoS attacks, which also are known as signaling storms. Since 5G and other next generation communication networks will facilitate massive IoT accessing the 5G and other next generation radio access network (RAN), this can increase the risk of RAN resource (e.g., 5G or other next generation RAN resource) overload by means of DDoS attacks disrupting services, including mission critical 5G and other next generation services, of the communication network.

There are existing techniques and mechanisms that can limit attaches by communication devices to the communication network. However, while the existing techniques and mechanisms can block at least some aggressive and/or malicious communication devices, the existing techniques and mechanisms also can undesirably (e.g., unsuitably) block, and can be likely to block, legitimate (e.g., benign) communication devices from attaching to the communication network. Further, legitimate communication devices typically can follow (e.g., comply with) the rules regarding back-off timers (e.g., back-off time between sending attach requests) and can wait the appropriate amount of time between each attach or registration request. At the same time, undesirably aggressive communication devices may continue to send attach requests to try to connect to the communication network. As a result, existing techniques and mechanisms, such as random throttling, may be likely to harm more legitimate communication devices than undesirably aggressive communication devices or at least can unduly harm legitimate communication devices that are trying to attach to or are connected to the communication network.

A significant challenge to identifying aggressive communication devices at the RAN can be that communication devices use temporary device identifiers in the RAN, as opposed to permanent or semi-permanent device identifiers, such as an international mobile equipment identity (IMEI) number or an international mobile subscriber identity (IMSI) associated with a communication device. Temporary device identifiers for communication devices can frequently change over time, including across attach attempts (e.g., across sending of attach or registration requests), which can inhibit, impede, or prevent correlating several attach or registration attempts from the same communication device based on temporary device identifiers. As a result, the existing techniques and mechanisms can be ineffective, inefficient, and/or otherwise undesirable, particularly in the RAN, in protecting the communication network against signaling storms (e.g., aggressive, excessive, and/or malicious signaling) by aggressive communication devices, while also enabling benign communication devices to attach to or register with the communication network. As a further result, attach or registration attempts from aggressive communication devices typically can make it passed the RAN and all the way to the core network, which can, or at least potentially can, undesirably inflict an overload of signaling from communication devices before undesired signaling can be blocked by the core network.

To that end, techniques for managing attachment of communication devices to a communication network, comprising detecting aggressive communication devices, distinguishing between aggressive communication devices and benign communication devices, and mitigating aggressive events associated with aggressive communication devices, are presented. The disclosed subject matter can comprise security management component (SMC) that can detect aggressive behavior (e.g., aggressive, excessive, and/or malicious signaling) by certain communication devices (e.g., aggressive communication devices) against a radio access network (RAN) and take a responsive or mitigation action (e.g., reject and/or block attach attempts) to mitigate the aggressive and/or malicious events associated with the certain communication devices, while allowing benign communication devices to attach to and communicate in the communication network. The SMC can analyze (e.g., perform an aggressive device detection analysis on) all or a desired portion (e.g., 70% or other desired percentage, or a desired number) of attach requests (or other types of requests or communications) received by the RAN from communication devices, such as more fully described herein.

In some embodiments, in response to receiving an attach request and associated information (e.g., temporary device identifier associated with a communication device, time information relating to sending of the attach request, and/or metadata), the SMC can analyze temporary device identifier data (e.g., a list of benign communication devices) associated with the RAN and the attach request and the associated information received from the communication device. Based at least in part on the results of the analysis and defined network security criteria, the SMC can reject the attach request if the temporary device identifier is determined to not be in a list of temporary device identifiers associated with benign communication devices in the temporary device identifier data and can store the temporary device identifier in the list of temporary device identifiers associated with benign communication devices; or the SMC can accept the attach request if the SMC determines that the temporary device identifier is the list of temporary device identifiers associated with benign communication devices and a threshold amount of time since the previous attach request associated with temporary device identifier is satisfied (e.g., met or exceeded). If the temporary device identifier is in the list of temporary device identifiers associated with benign communication devices in the temporary device identifier data, this can indicate that the communication device associated with the temporary device identifier had sent a previous attach request (e.g., a first attach request) to the RAN and the previous attach request was rejected, in accordance with defined network security criteria (e.g., defined network security criteria that indicates or specifies that a first attach request associated with a temporary device identifier associated with a communication device is to be rejected). Accordingly, if the communication device had a first attach request associated with the temporary device identifier rejected by the SMC, and sends another attach request associated with a different temporary device identifier to the RAN, the SMC can determine that the different temporary device identifier is not in the temporary device identifier data associated with the RAN (e.g., since that is the first attach request using the different temporary device identifier) and can reject that other attach request associated with the different temporary device identifier, in accordance with the defined network security criteria.

If the attach request (e.g., second attach request) was accepted, the communication device can be attached, registered, and/or connected to or with the communication network. The SMC can continue to monitor attach requests received by the RAN from communication devices, including the communication device. If the communication device subsequently detaches from the communication network and sends another attach request associated with temporary device identifier to quickly reattach to the communication network (e.g., if the communication device associated with the temporary device identifier is quickly detaching from and sending another attach request to attempt to reattach to the communication network in an undesirably aggressive manner), the SMC can reject the attach request (e.g., even if the other attach request satisfied the defined threshold amount of time), identify the communication device as an aggressive communication device, remove the temporary device identifier from the list of temporary device identifiers associated with benign communication devices, and place the temporary identifier data on a list of temporary device identifiers associated with aggressive communication devices, in accordance with the defined network security criteria. The SMC can reject or block any future attach requests associated with the temporary device identifier associated with the communication device based at least in part on the SMC determining that the temporary device identifier is in the list of temporary device identifier associated with aggressive communication devices.

These and other aspects and embodiments of the disclosed subject matter will now be described with respect to the drawings.

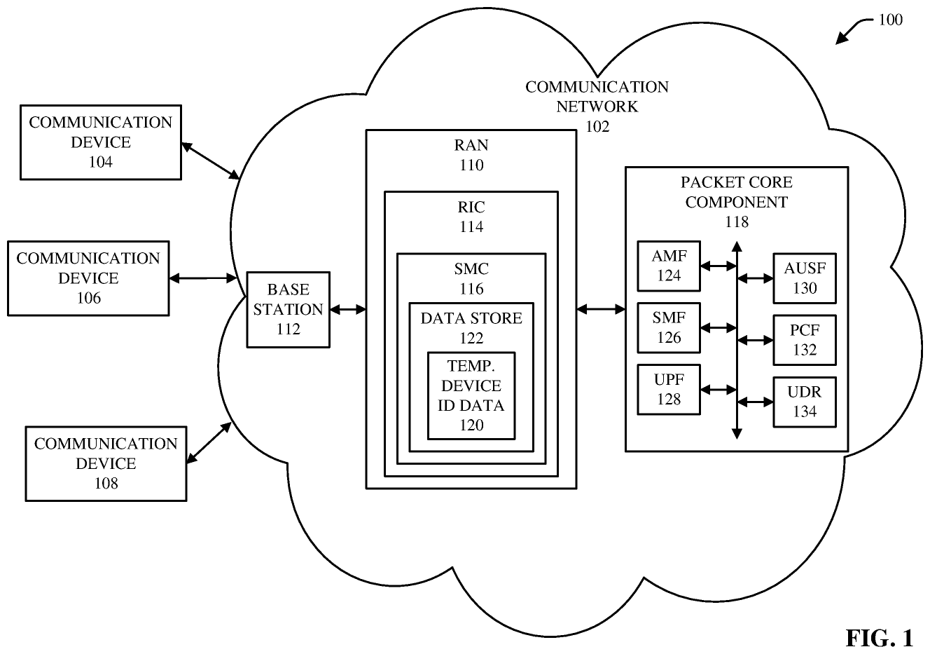

Referring now to the drawings, FIG. 1 illustrates a block diagram of an example system 100 that can distinguish between benign communication devices and aggressive communication devices to facilitate mitigating aggressive and/or malicious events by aggressive communication devices against a radio access network (RAN) of a communication network and can manage connection of communication devices to the RAN, in accordance with various aspects and embodiments of the disclosed subject matter. The system 100 can comprise a communication network 102 can comprise a mobility core network (e.g., a wireless communication network) and/or a packet data network (e.g., an Internet Protocol (IP)-based network, such as the Internet and/or intranet) that can be associated with the mobility core network.

The mobility core network (e.g., LTE, 5G, or other next generation (e.g., xG) core network) of the communication network 102 can operate to enable wireless communication between communication devices and/or between a communication device and the communication network 102. The communication network 102 can comprise various components, such as network (NW) nodes, e.g., radio network nodes) that can be part of the communication network 102 to facilitate communication of information between devices (e.g., communication devices) that can be associated with (e.g., communicatively connected to) the communication network 102. In some embodiments, the communication network 102 can employ MIMO technology to facilitate data communications between devices (e.g., network devices, communication devices, or other devices) associated with the communication network 102.

As used herein, the terms “network node,” “network node component,” and “network component” can be interchangeable with (or include) a network, a network controller, or any number of other network components. Further, as utilized herein, the non-limiting term radio network node, or network node can be used herein to refer to any type of network node serving communications devices and/or connected to other network nodes, network elements, or another network node from which the communications devices can receive a radio signal. In cellular radio access networks (e.g., universal mobile telecommunications system (UMTS) networks), network nodes can be referred to as base transceiver stations (BTS), radio base station, radio network nodes, base stations, NodeB, eNodeB (e.g., evolved NodeB), and so on. In 5G terminology, the network nodes can be referred to as gNodeB (e.g., gNB) devices. Network nodes also can comprise multiple antennas for performing various transmission operations (e.g., MIMO operations). A network node can comprise a cabinet and other protected enclosures, an antenna mast, and actual antennas. Network nodes can serve several cells, also called sectors, depending on the configuration and type of antenna. Network nodes can be, for example, Node B devices, base station (BS) devices, access point (AP) devices, TRPs, and radio access network (RAN) devices. Other examples of network nodes can include multi-standard radio (MSR) nodes, comprising: an MSR BS, a gNodeB, an eNodeB, a network controller, a radio network controller (RNC), a base station controller (BSC), a relay, a donor node controlling relay, a BTS, an AP, a transmission point, a transmission node, a Remote Radio Unit (RRU), a Remote Radio Head (RRH), nodes in distributed antenna system (DAS), and the like. In accordance with various embodiments, a network node can be, can comprise, or can be associated with (e.g., communicatively connected to) a network device of the communication network 102.

At given times, one or more communication devices, such as, for example, communication device 104, communication device 106, and communication device 108, can attach or connect, or attempt to attach or connect, to the communication network 102 to communicate with other communication devices associated with the communication network 102. A communication device (e.g., 104, 106, or 108) also can be referred to as, for example, a device, a mobile device, or a mobile communication device. The term communication device can be interchangeable with (or include) a UE or other terminology. A communication device (or UE, device, or other similar term) can refer to any type of wireless device that can communicate with a radio network node in a cellular or mobile communication system. Examples of communication devices can include, but are not limited to, a device to device (D2D) UE, a machine type UE or a UE capable of machine to machine (M2M) communication, a Personal Digital Assistant (PDA), a tablet or pad (e.g., an electronic tablet or pad), an electronic notebook, a mobile terminal, a cellular and/or smart phone, a computer (e.g., a laptop embedded equipment (LEE), a laptop mounted equipment (LME), or other type of computer), a smart meter (e.g., a smart utility meter), a target device, devices and/or sensors that can monitor or sense conditions (e.g., health-related devices or sensors, such as heart monitors, blood pressure monitors, blood sugar monitors, health emergency detection and/or notification devices, or other type of device or sensor), a broadband communication device (e.g., a wireless, mobile, and/or residential broadband communication device, transceiver, gateway, and/or router), a dongle (e.g., a Universal Serial Bus (USB) dongle), an electronic gaming device, electronic eyeglasses, headwear, or bodywear (e.g., electronic or smart eyeglasses, headwear (e.g., augmented reality (AR) or virtual reality (VR) headset), or bodywear (e.g., electronic or smart watch) having wireless communication functionality), a music or media player, speakers (e.g., powered speakers having wireless communication functionality), an appliance (e.g., a toaster, a coffee maker, a refrigerator, or an oven, or other type of appliance having wireless communication functionality), a set-top box, an IP television (IPTV), a device associated or integrated with a vehicle (e.g., automobile, airplane, bus, train, or ship, or other type of vehicle), a virtual assistant (VA) device, a drone, a home or building automation device (e.g., security device, climate control device, lighting control device, or other type of home or building automation device), an industrial or manufacturing related device, a farming or livestock ranch related device, and/or any other type of communication devices (e.g., other types of IoTs).

It is noted that the various aspects of the disclosed subject matter described herein can be applicable to single carrier as well as to multicarrier (MC) or carrier aggregation (CA) operation of the communication device. The term carrier aggregation (CA) also can be referred to (e.g., interchangeably called) “multi-carrier system,” “multi-cell operation,” “multi-carrier operation,” “multi-carrier” transmission and/or reception. In addition, the various aspects discussed can be applied for Multi RAB (radio bearers) on some carriers (e.g., data traffic and voice traffic can be simultaneously scheduled).

It is to be appreciated and understood that the terms element (e.g., element in connection with an antenna), elements, and antenna ports also can be used interchangeably, but can carry the same meaning, in this subject disclosure. In some embodiments, more than a single antenna element can be mapped to a single antenna port.

As disclosed, the mobility core network of the communication network 102 can comprise various network components or devices, which can include one or more RANs, such as, for example, RAN 110, wherein each RAN can comprise or be associated with a set of base stations (e.g., access points (APs)), such as base station 112, that can serve communication devices located in respective coverage areas served by respective base stations in the mobility core network of the communication network 102. The respective base stations (e.g., 112) can be associated with one or more sectors (not shown), wherein respective sectors can comprise respective cells. The cells can have respective coverage areas that can form the coverage area covered by the one or more sectors. The respective communication devices can be communicatively connected to the communication network 102 via respective wireless or wireline communication connections with one or more of the respective cells.

In some embodiments, the one or more RANs (e.g., RAN 110) can be based on open-RAN (O-RAN) technology and standards. These standards can define the open interface that can support interoperability of network elements (e.g., radio unit (RU), central unit (CU), distributed unit (DU), real or near real time RAN intelligent controller (RIC), or other type of network element) from different entities (e.g., vendors). The network elements may be virtualized, e.g., software-based components that can run on a common virtualization/cloud platform. In certain embodiments, the O-RAN based RAN can utilize a common platform that can reduce reliance on proprietary platforms of service providers. The O-RAN based RAN also can employ standardized interfaces and application programming interfaces (APIs) to facilitate open source implementation of the O-RAN based RAN.

The number of communication devices, particularly IoT devices, being utilized is increasing at a significant rate and can be expected to continue to increase significantly into the future (e.g., increase to tens of billions of devices). While in most instances, the communication devices (e.g., 104, 106, or 108) and associated users can be attempting to connect to the RAN 110 for appropriate or benign reasons, in some instances, aggressive or malicious actors can utilize communication devices to attempt to connect to the RAN 110 to disrupt (e.g., obstruct or interrupt) services, such as mobility services, provided by the communication network 102, including the RAN 110. For example, malicious actors can utilize communication devices (e.g., communication device 108), such as IoT devices, and exploit vulnerabilities of such devices (e.g., by installing malware on such communication devices) to initiate a malicious event, such as a DDoS attack, against the RAN 110 to overwhelm the RAN 110 and disrupt the services provided by the RAN 110 and/or associated communication network 102, including disrupting communication between communication devices (e.g., non-malicious acting communication devices, such as communication devices 104 and 106) connected to or attempting to connect to the RAN 110 and/or associated communication network 102, as more fully described herein. The disclosed subject matter can determine (e.g., intelligently, automatically, and/or dynamically) determine when malicious events against the RAN 110 by certain (e.g., malicious and/or malware infected) communication devices is occurring (e.g., in real time or substantially in real time (e.g., near real time)), as more fully described herein.

In some cases, there can be communication devices that are attempting to connect to the RAN 110 to communicate priority (e.g., high priority or critical) messages, via the RAN 110, to other communication devices associated with the communication network 102. If there is an aggressive (e.g., aggressive and/or malicious) event against the RAN 110 detected, the aggressive event, if not mitigated, can, or potentially can, disrupt services of the RAN 110 to prevent a benign communication device attempting to connect and communicate a message (e.g., a priority or other desired message) via the RAN 110, and/or, if all communication devices attempting to connect to the RAN 110 during an aggressive event were to be blocked from connecting, that can undesirably (e.g., negatively) impact the ability of those benign communication devices that are attempting to connect to the RAN 110 to communicate desired (e.g., benign and/or priority) messages from doing so. The disclosed subject matter can desirably (e.g., intelligently, automatically, and/or dynamically in real time or substantially in real time) analyze attach requests received from communication devices and associated information (e.g., temporary device identifiers, time information, metadata), and, from the analysis, can desirably distinguish between benign communication devices and aggressive communication devices and can reject attach requests of aggressive communication devices, in accordance with defined network security criteria, as more fully described herein.

To that end, in some embodiments, the RAN 110 can comprise a RIC 114 that can manage various functions and resources of or associated with the RAN 110 in real time or substantially close (e.g., near) to real time. To facilitate securing the RAN 110 and communication network 102 overall from aggressive events (e.g., aggressive actions and/or malicious attacks, such as DDoS attacks), the RIC 114 can comprise or be associated with a security management component (SMC) 116 that can detect aggressive communication devices (e.g., communication device 108), can distinguish between aggressive communication devices and benign communication devices (e.g., communication devices 104 and 106), can mitigate aggressive and/or malicious events (e.g., aggressive, excessive, malicious, and/or otherwise undesirable signaling) against the RAN 110 by undesirably aggressive communication devices, and can manage attaching, registration, and/or connection of communication devices (e.g., 104, 106, or 108) to the RAN 110 and associated core network (e.g., manage attaching, registration, and/or connection of communication devices during aggressive and/or malicious events), in accordance with the defined network security criteria. In some embodiments, the SMC 116 can employ a security application (e.g., aggressive device detector, aggressive and/or malicious event detector, and/or DDoS application) to facilitate detecting and mitigating aggressive and/or malicious communication devices and associated aggressive and/or malicious events against the RAN 110, and managing (e.g., controlling) attachments, registrations, and/or connections of communication devices to the RAN 110 or associated communication network 102. For example, the security application can be a micro services application (e.g., xApp) that can be part of or built on top of the RIC 114. The SMC 116, by performing the functions and operations described herein, can detect aggressive and/or malicious communication devices (e.g., 108) and perform a mitigation or responsive action to mitigate (e.g., reduce or minimize) the aggressive and/or malicious behavior of such aggressive and/or malicious communication devices at the RAN level (e.g., at the RAN 110) of the communication network 102, which can mitigate (e.g., reduce or minimize) the impact (e.g., negative impact) of such aggressive and/or malicious communication devices not only at the RAN level but also at the packet core component 118 and other network equipment of the communication network 102.

Communication devices (e.g., 104, 106, or 108) can communicate attach requests (e.g., attach or registration requests) or other types of communications to the RAN 110 to facilitate obtaining services or resources from the RAN 110. For instance, a communication device (e.g., communication device 104) can communicate an attach request (e.g., initial attach request) to the RAN 110 to request connection to the RAN 110, or a communication device can communicate another type of attach request (e.g., update request, such as an authentication update request, or a packet data network (PDN) gateway (PGW) update request, or other type of attach request) to the RAN 110 to request another type of service or resources from the RAN 110.

When communication devices (e.g., 104, 106, or 108) communicate attach requests or other types of communications to the RAN 110, the SMC 116 can receive information comprising or relating to such attach requests or other types of communications. The RAN 110 and the SMC 116 can receive the information contained in an attach request or other type of communication from the communication device (e.g., communication device 104) and/or can receive other information (e.g., other attach request-related information) from the communication device or network devices of the communication network 102. For instance, the SMC 116 (and/or the RAN 110) can receive device identifier information (e.g., IMEI number, IMSI, or other unique device identifier or serial number) that can identify the communication device, device location information that can identify the location of the communication device, device type information that can identify the type of device the communication device is, priority information that can indicate or specify a priority level associated with the communication device or message associated with the communication device, time data (e.g., time stamp data) that can indicate the time of the attach request or type of communication or time(s) associated with another item(s) of attach request-related information, metadata associated with the attach request and/or communication device, and/or other type of attach request-related information.

The IMEI and IMSI can be permanent or semi-permanent that a communication device can use. The IMEI can be part of the communication device itself. The IMSI can be stored on a subscriber identity (or identification) module (SIM) card of the subscriber, which can be inserted into the communication device. The IMEI and IMSI can be considered sensitive data since attackers (e.g., malicious users) can use them to eavesdrop on phone calls, hijack the identity of the subscriber, engage in or execute fraudulent transactions (e.g., financial transactions) using the subscriber's identity and/or the IMEI or IMSI, spoof text messages to appear as if such text messages are coming from the subscriber's communication device, track the location of the communication device and associated subscriber, and/or engage in other undesired activities. For this reason, the IMEI and IMSI can be encrypted upon transmission over the air and they are not available for the RAN 110 (e.g., the RAN 110 is not able to decrypt the encrypted IMEI and/or IMSI.

Instead, the RAN 110 can use temporary device identifiers (e.g., temporal (e.g., temporary) random or pseudo-random identifiers) as a reference to or for communication devices (e.g., mobile or wireless communication devices) and/or associated subscribers. The SMC 116 can store temporary device identifier data 120 comprising information relating to at least some temporary device identifiers associated with communication devices in a data store 122. A temporary device identifier can identify a communication device (e.g., 104, 106, or 108) for a relatively short period of time, across current transactions involving the communication device, where the temporary device identifier can change over time for the communication device. In some embodiments, the short period of time the temporary device identifier is used for a communication device can be indeterminate, unknown, or undefined. Examples of temporary device identifiers can comprise cell radio network temporary identifier (C-RNTI) and temporary mobile subscriber identity (TMSI). A C-RNTI can be a temporary unique identifier that can be allocated by a base station 112 (e.g., eNB for LTE, or gNB for 5G) relatively early in a communication setup during a random access stage associated with a communication device (e.g., 104, 106, or 108). A C-RNTI can be used, instead of the IMEI, for example, for identifying a radio resource control (RRC) connection and scheduling that can be dedicated to a communication device. A TMSI can be a temporary unique identifier that can be allocated by the packet core component 118 (e.g., an access and mobility management function (AMF) 124 for 5G, or a mobility management entity (MME) for LTE) associated with (e.g., communicatively connected to) the RAN 110. A communication device (e.g., 104, 106, or 108) can send the TMSI, for example, as part of an RRC setup request (RRCSetupRequest). The TMSI can be used, instead of the IMSI, for example, to ensure or maintain the privacy of the subscriber associated with a communication device. With regard to a 5G communication network, the value of a TMSI can be the allocated ng-5G-S-TMSI-Part1 or a random (or pseudo-random) value. The ng-5G-S-TMSI-Part1 typically can only be used if it was determined earlier by the communication network 102. To facilitate more desirable security of the communication network 102 and communication device, usage of a random value for the TMSI can be desirable (e.g., can be more suitable, can be encouraged, and/or can be more secure).

In some embodiments, the SMC 116 can utilize the TMSI to facilitate detecting aggressive communication devices and distinguishing between aggressive communication devices and non-aggressive (e.g., benign) communication devices. Out of the C-RNTI and the TMSI, the base station 112 can allocate the C-RNTI arbitrarily without knowing the device identity of the communication device. As a result, the SMC 116 (e.g., the security application and associated throttling mechanism of the SMC 116) typically would not be able to use the C-RNTI to detect aggressive communication devices and distinguish between aggressive communication devices and non-aggressive communication devices without certain changes being made to network standards and/or network elements of the communication network 102, which may include certain changes to C-RNTI related procedures employed by the communication network 102. In certain embodiments though, if and as desired, such certain changes can be made to the network standards and/or network elements of the communication network 102, and/or the C-RNTI related procedures of the communication network 102, to enable the SMC 116 to utilize the C-RNTI to facilitate detecting aggressive communication devices and distinguishing between aggressive communication devices and non-aggressive communication devices.

With further regard to the TMSI, it is noted that, if the same TMSI value is used for each communication device over time, the SMC 116 (e.g., the security application and associated throttling mechanism of the SMC 116) can distinguish aggressive (e.g., harmful or malicious) communication devices and can apply a mitigation or responsive action (e.g., can apply the throttling mechanism) to only the aggressive communication devices. In practice though, one problem can be that a new random value for TMSI can or may be used for attach or registration events (e.g., attach or registration requests) by aggressive communication devices. In accordance with the disclosed subject matter, communication devices can reuse their random value for TMSI after a failed or rejected attach or registration attempt. After a successful attach to the communication network 102 by a communication device, the communication device can “forget” or discontinue the use of the random number for TMSI and can generate a new random number for TMSI for the next time of an attach or registration event. It is noted that refreshing of the random number for TMSI can be desirable for security reasons. It also is noted that, in the event of a signaling storm by aggressive communication devices, reusing of the random number for TMSI by a communication device for two attach or registration requests can still keep the permanent device identifier (e.g., IMEI or IMSI) desirably safe.

Employing the techniques and algorithms of the disclosed subject matter, the SMC 116 can perform an aggressive device detection analysis to detect aggressive behavior (e.g., aggressive, excessive, and/or malicious signaling) by aggressive communication devices (e.g., aggressive and/or malicious communication devices, such as communication device 108) against the RAN 110 and associated communication network 102 and can perform a responsive or mitigation action (e.g., reject and/or block attach or registrations requests or other communications of aggressive communication devices) to mitigate the aggressive and/or malicious events associated with the aggressive communication devices and the impact (e.g., negative impact) of such aggressive and/or malicious events, while allowing benign communication devices (e.g., communication devices 104 and 106) to attach to, register with, and communicate in the communication network 102, in accordance with the defined network security criteria.

In some embodiments, the SMC 116 can monitor signaling associated with the communication devices (e.g., 104, 106, and/or 108) interacting or attempting to interact with the RAN 110; and, from the monitoring of signaling, based at least in part on analysis of signaling associated with communication devices, the SMC 116 can determine (e.g., automatically determine) whether the amount (e.g., level) of signaling satisfies (e.g., meets or exceeds; is at or greater than) a defined threshold amount (e.g., maximum amount) of signaling that can indicate aggressive or potentially aggressive behavior being exhibited by one or more communication devices, in accordance with the defined network security criteria (e.g., when specified by the defined network security criteria). If the SMC 116 determines that the amount of signaling does not satisfy the defined threshold amount of signaling, the SMC 116 can determine that no aggressive or potentially aggressive signaling associated with communication devices has been detected and the aggressive device detection analysis does not have to be performed. If the SMC 116 determines that the amount of signaling does satisfy the defined threshold amount of signaling, the SMC 116 can determine (e.g., automatically determine) that aggressive or potentially aggressive signaling associated with communication devices has been detected, the aggressive device detection analysis is to be performed, and can perform the aggressive device detection analysis. For instance, the SMC 116 can determine that the aggressive device detection analysis is to be performed when (e.g., only when) the SMC 116 determines, and in response to the SMC 116 determining, that a cell(s), base station(s) (e.g., 112), RAN (e.g., 110), packet core component 118, network element(s), other network equipment, and/or portion (e.g., region) of the communication network 102 is under an undesirably high load (e.g., an undesirably high signaling load). Thus, if the SMC 116 detects or determines that there is an undesirably or unusually high volume of attach requests and/or other signaling associated with communication devices (e.g., 104, 106, and/or 108) interacting with a cell(s), base station (e.g., 112), RAN (e.g., 110), packet core component 118, network element(s), other network equipment, and/or portion of the communication network 102, the SMC 116 can perform the aggressive device detection analysis, whereas, during other times, when the SMC 116 does not detect an undesirably or unusually high volume of attach requests and/or other signaling associated with communication devices interacting with a cell(s), base station, RAN, packet core component 118, network element(s), other network equipment, and/or portion of the communication network 102, the SMC 116 can determine that the aggressive device detection analysis is not to be performed.

In certain embodiments, additionally or alternatively, the SMC 116 can determine whether to perform the aggressive device detection analysis based at least in part on whether the SMC 116 receives a suspected aggressive device report message that indicates that aggressive (e.g., aggressive, excessive, and/or malicious) activity or potentially aggressive activity associated with one or more communication devices (e.g., 108) associated with the communication network 102, or portion thereof, has been detected (e.g., indicates a suspected attack on the communication network 102, or portion thereof, has been detected). For instance, a user (e.g., an operator or other service personnel associated with a service provider associated with (e.g., owning, operating, or managing) the communication network 102, or portion thereof) or an external system (e.g., external automated system) associated with the SMC 116 or communication network 102 can monitor the communication network 102, or portion thereof, for undesirable network conditions (e.g., excessive signaling of communication devices and/or undesirable loading of the communication network 102, or portion thereof). If the user or the external system detects or identifies such undesirable network conditions that can indicate aggressive activity (e.g., aggressive behavior) or potentially aggressive activity associated with one or more communication devices (e.g., 108) is occurring, the user or the external system (e.g., using a communication device) can communicate a suspected aggressive device report message, comprising suspected aggressive device report data, that can indicate that aggressive activity or potentially aggressive activity associated with one or more communication devices has been detected or identified and can provide other desired information (e.g., time of the detection of such activity, level of signaling associated with communication devices, device-related information associated with communication devices (e.g., device location information, device identifiers, or other device-related information), information indicating the portion of the communication network affected by such activity, and/or other relevant information). In response to receiving the suspected aggressive device report message, the SMC 116 can perform the aggressive device detection analysis (or at least can determine whether the aggressive device detection analysis is to be performed), in accordance with the defined network security criteria.

The SMC 116, by performing the aggressive device detection analysis when the applicable threshold amount of signaling has been satisfied (instead of, for example, on a continuous basis) or when a suspected aggressive device report message has been received, can desirably protect and secure the communication network 102 from aggressive signaling, while also desirably (e.g., suitably, enhancedly, and/or optimally) managing resources of the communication network 102, including the RAN 110, to reduce or minimize the amount of resources used to perform the aggressive device detection analysis and/or other overhead (e.g., rejecting of first attach attempts by communication devices) associated with the aggressive device detection analysis, while also providing a desirable (e.g., desirably high) level of service to communication devices (e.g., benign communication devices, such as communication devices 104 and 106) interacting with or connecting to the communication network 102 and/or desirably reducing the amount of load on the cell(s), base station(s), RAN, or other portion of the communication network 102.

In other embodiments (e.g., alternatively), if and as desired, the SMC 116 can perform the aggressive device detection analysis on a continuous, regular, periodic, or aperiodic basis on attach or registration requests (and/or other types of requests, communications, and/or signals, if and as desired) received from communication devices (e.g., 104, 106, and/or 108) interacting or attempting to interact with the RAN 110, in accordance with the defined network security criteria (e.g., if and when doing so is specified by the defined network security criteria). It is noted that, typically, it can be desirable to not continuously perform the aggressive device detection analysis, as there can be additional network resources utilized and/or additional overhead incurred when performing the aggressive device detection analysis and associated algorithms Rather, as disclosed, it can be desirable for the SMC 116 to perform the aggressive device detection analysis in response to detecting that a cell(s), base station(s) (e.g., 112), RAN (e.g., 110), packet core component 118, network element(s), other network equipment, and/or portion of the communication network 102 is under an undesirably high load (e.g., in response to determining that the amount of signaling associated with one or more communication devices satisfies the defined threshold amount of signaling) or in response to the SMC 116 receiving a suspected aggressive device report message.

The SMC 116 can determine and/or apply respective threshold amounts of signaling for respective RANs (e.g., RAN 110) or respective base stations (e.g., base station 112) based at least in part on the respective characteristics associated with the respective RANs or respective base stations, respective times of day, respective days of week, respective times of year, and/or other factors, in accordance with the defined network security criteria. The characteristics can relate to location of the RAN or base station, a typical number of communication devices connected to or in proximity to a RAN or base station during a particular time of day, day of the week, or time of the year, a typical amount of signaling for a particular time of day, day of the week, or time of the year, and/or other desired characteristics. For example, if the characteristics of a RAN indicate that that RAN has a relatively high level of signaling during regular business hours, the SMC 116 can set the defined threshold amount of signaling during regular business hours at a relatively higher amount that can correspond to or correlate to the relatively high level of signaling during regular business hours. If the characteristics of a RAN indicate that that RAN has a relatively lower level of signaling during evening hours, the SMC 116 can set the defined threshold amount of signaling during evening hours at a relatively lower amount that can correspond to or correlate to the relatively lower level of signaling during evening hours. If the characteristics of a RAN indicate that that RAN is located in or covers a rural area that has a relatively low level of signaling, the SMC 116 can set the defined threshold amount of signaling at a relatively lower amount that can correspond to or correlate to the relatively low level of signaling in that rural area. If the characteristics of a RAN indicate that that RAN is located in or covers a relatively busy metropolitan area that has a relatively higher level of signaling, the SMC 116 can set the defined threshold amount of signaling at a relatively higher amount that can correspond to or correlate to the relatively high level of signaling in that metropolitan area.

In certain embodiments, when the SMC 116 is performing the aggressive device detection analysis, the SMC 116 can analyze (e.g., perform an aggressive device detection analysis on) all or a desired portion (e.g., 70% or other desired percentage, or a desired number) of attach requests (or other types of requests, communications, and/or signaling) received by the RAN 110 from communication devices (e.g., communication devices 104, 106, and/or 108), such as more fully described herein.

In some embodiments, when performing the aggressive device detection analysis, in response to receiving an attach request and associated information (e.g., temporary device identifier associated with a communication device (e.g., 104, 106, or 108), time information relating to sending of the attach request, and/or metadata), the SMC 116 can analyze temporary device identifier data 120 (e.g., a list of temporary device identifiers associated with benign communication devices and/or a list of temporary device identifiers associated with aggressive communication devices) associated with the RAN 110 and the attach request and the associated information received from the communication device. Based at least in part on the results of the analysis and the defined network security criteria, the SMC 116 can reject or block the attach request if the temporary device identifier is determined to not be in the temporary device identifier data 120 (e.g., determined to not match any temporary device identifier in the list of temporary device identifiers associated with benign communication devices) and can store the temporary device identifier in the temporary device identifier data (e.g., in the list of temporary device identifiers associated with benign communication devices). If the temporary device identifier matches a temporary device identifier in the list of temporary device identifiers associated with aggressive communication devices (e.g., devices previously determined to be aggressive), the SMC 116 can reject or block the attach request.

If, based at least in part on the results of the analysis and the defined network security criteria, the SMC 116 determines that the temporary device identifier is in the temporary device identifier data 120 (e.g., determines the temporary device identifier matches a temporary device identifier in the list of temporary device identifiers associated with benign communication devices) and a threshold amount of time since the previous attach request associated with temporary device identifier is satisfied (e.g., met or exceeded), the SMC 116 can accept the attach request, as more fully described herein. If the temporary device identifier is in the list of temporary device identifiers associated with benign communication devices in the temporary device identifier data 120, this can indicate that the communication device associated with the temporary device identifier had sent a previous attach request (e.g., a first attach request) to the RAN 110 and the previous attach request was rejected, in accordance with defined network security criteria (e.g., defined network security criteria that indicates or specifies that a first attach request associated with a temporary device identifier associated with a communication device is to be rejected). Accordingly, if the communication device had a first attach request associated with the temporary device identifier rejected by the SMC 116, and sends another attach request associated with a different temporary device identifier to the RAN 110, the SMC 116 can determine that the different temporary device identifier is not in the list of temporary device identifiers associated with benign communication devices in the temporary device identifier data 120 associated with the RAN 110 (e.g., since that is the first attach request using the different temporary device identifier) and can reject that other attach request associated with the different temporary device identifier, in accordance with the defined network security criteria, as more fully described herein.

If the attach request (e.g., second attach request) was accepted by the SMC 116, the SMC 116 can allow the attach request to continue to proceed and the communication device can be connected to the communication network 102, such as described herein. The SMC 116 can continue to monitor attach requests received by the RAN 110 from communication devices (e.g., 104, 106, and/or 108), including the communication device. If the communication device subsequently detaches from the communication network 102 and sends another attach request associated with the temporary device identifier to quickly reattach to the communication network 102 (e.g., if the communication device associated with the temporary device identifier is quickly detaching from and sending another attach request to attempt to reattach to the communication network 102 in an undesirably aggressive manner), the SMC 116 can reject or block the attach request (e.g., even if the other attach request satisfied the defined threshold amount of time), identify the communication device (e.g., 108) as an aggressive communication device, remove the temporary device identifier from the list of temporary device identifiers associated with benign communication devices, and place the temporary identifier data on the list of temporary device identifiers associated with aggressive communication devices in the temporary device identifier data 120, in accordance with the defined network security criteria, as more fully described herein. The SMC 116 also can reject or block any future attach requests and/or other signaling associated with the temporary device identifier associated with the communication device based at least in part on the SMC 116 determining that the temporary device identifier is in the list of temporary device identifiers associated with aggressive communication devices.

It is to be appreciated and understood that, while various aspects and embodiments of the disclosed subject matter are described herein with regard to 5G and other next generation communication networks, the techniques of the disclosed subject matter described herein can be utilized (e.g., applied to), in same or similar form, to 4G communication networks, and the disclosed subject matter includes all such aspects and embodiments relating to implementation of the techniques of the disclosed subject matter to 4G communication networks.

Other aspects and embodiments of the disclosed subject matter will be described with regard to the other figures (and/or FIG. 1).

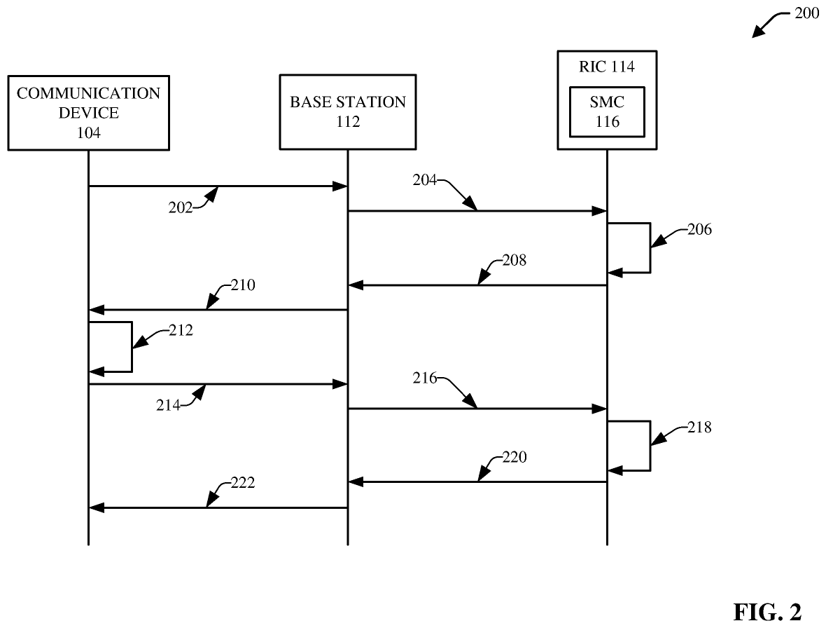

Referring to FIG. 2 (along with FIG. 1), FIG. 2 depicts a block diagram of an example attach request processing flow 200 relating to a communication device that can be attempting to attach, register, or connect, to or with the RAN and can be determined to be acting in a benign manner by the SMC, in accordance with various aspects and embodiments of the disclosed subject matter. As part of the attach request processing flow 200, a communication device 104 can communicate an attach request and associated information to the base station 112, as indicated at reference numeral 202. The attach request can comprise or be associated with other information, such as a device identifier (e.g., IMEI, IMSI, or other type of identifier), which can identify the communication device 104 and/or associated subscriber, and/or metadata (e.g., time information, such as a time stamp or time indicator that can indicate the time that the attach request was made). The device identifier can be communicated in an encrypted form such that the base station 112, RAN 110, and other network equipment outside of the packet core component 118 (e.g., packet core network equipment of the core network) are not able to identify or determine the device identifier. In some embodiments, the other information of or associated with the attach request can comprise a temporary device identifier, such as a TMSI, that can be temporarily used to identify the communication device 104. The base station 112 can receive the attach request and the associated information. In certain embodiments, in addition to or as an alternative to using a TMSI associated with the communication device 104 as a temporary device identifier, the disclosed subject matter can utilize a C-RNTI as a temporary device identifier, wherein the base station 112 can generate and assign a C-RNTI as a temporary device identifier for the communication device 104, and can associate or include such temporary device identifier with the attach request. If no time information is yet associated with the attach request, the base station 112 can include time information relating to the attach request (e.g., time of sending of the attach request by the communication device 104, or time of receiving the attach request from the communication device 104) with the associated information.

As indicated at reference numeral 204 of the attach request processing flow 200, the base station 112 can communicate the attach request and the associated information, including the device identifier (e.g., encrypted device identifier), temporary device identifier, and/or other metadata (e.g., the time information associated with the attach request), to the RIC 114 at the RAN 110. As indicated at reference numeral 206 of the attach request processing flow 200, the SMC 116 of or associated with the RIC 114 can analyze the attach request and the associated information and also can analyze temporary device identifier data (TEMPORARY DEVICE ID DATA) 120 stored in the data store 122, and based at least in part on the results of the analysis, the SMC 116 can determine that the temporary device identifier is not contained in the temporary device identifier data 120 (e.g., not contained in the list of benign devices) associated with the RAN 110, can determine that this is the first attach request by the communication device 104 that is associated with the temporary device identifier, can store the temporary device identifier and/or other information relating to the attach request in the temporary device identifier data 120 (e.g., in the list of benign devices) in the data store 122, and can determine that the attach request is to be rejected, in accordance with the defined network security criteria. The defined network security criteria can indicate or specify that first attach requests associated with a temporary device identifiers associated with communication devices, or at least a desired portion of such first attach requests, are to be rejected, and accordingly, the SMC 116 can reject the first attach request associated with the temporary device identifier associated with the communication device 104. In this example instance, the SMC 116 (e.g., the throttling xApp of the SMC 116) can reject or block the first attach attempt associated with the temporary identifier associated with the communication device 104 because, at this point, the SMC 116 does or may not sufficient information to distinguish the communication device 104 from an undesirably aggressive and/or malicious communication device. The temporary device identifier data 120 associated with the RAN 110 can be or can comprise, for example, the list of temporary device identifiers associated with certain communication devices, such as communication devices determined to be, or at least provisionally (e.g., preliminarily or conditionally) determined to be, benign (e.g., non-aggressive) devices. The SMC 116 can update the temporary device identifier data 120 to register the temporary device identifier associated with the communication device 104 in the temporary device identifier data 120 (e.g., in the list of benign devices).

In response to determining that the attach request is to be rejected due in part to the temporary device identifier not being found in the temporary device identifier data 120 and the attach request under consideration being the first attach request by the communication device 104 that is associated with the temporary device identifier, the SMC 116 can communicate a rejection message relating to the attach request to the base station 112 to notify the base station 112 that the attach request has been rejected, as indicated at reference numeral 208 of the attach request processing flow 200. In some embodiments, the SMC 116 can communicate rejection instructions to the RAN 110, base station 112, and/or packet core component 118 that can instruct that the attachment, registration, and/or connection of the communication device 104 to or with the communication network 102 is to be rejected or blocked. As indicated at reference numeral 210 of the attach request processing flow 200, the base station 112 can communicate the rejection message relating to the attach request to the communication device 104 to notify the communication device 104 that the attach request has been rejected. In some embodiments, the rejection message can comprise the temporary device identifier that was assigned to the communication device 104 and/or other desired information.

The defined network security criteria can comprise a network security criterion that can indicate or specify that a defined threshold amount of time is to elapse between a first attempt at an attach request by a communication device and a second attempt at an attach request by the communication device, and, if the communication device sends a second attach request before the defined threshold amount of time has elapsed since the first attach request, such failure to satisfy (e.g., meet) the defined threshold amount of time by the communication device can be or can indicate undesirable aggressive behavior by the communication device. The defined threshold amount of time can be, for example, 10 seconds or another desired amount of time, which can be greater than or less than 10 seconds, as indicated or specified by the defined network security criteria. As indicated at reference numeral 212 of the attach request processing flow 200, the SMC 116 can implement the defined threshold amount of time (e.g., as a backoff timer) and/or monitor or track the amount of time between the first attach request and a second attach request (if any) from the communication device 104 associated with the temporary device identifier, in accordance with the defined network security criteria. At this point, the communication device 104 can fall into this wait time between attach requests based on the backoff timer.

As indicated at reference numeral 214 of the attach request processing flow 200, at a second time (e.g., a subsequent time), the communication device 104 can communicate a second attach request and associated information to the base station 112. In this example case of the attach request processing flow 200, the communication device 104 has waited the defined threshold amount of time (e.g., has waited for the backoff amount of time or backoff timer to be finished) before sending the second attach request to the base station 112 and, at least with regard to the defined threshold amount of time, the communication device 104 is acting in a desirable benign (e.g., non-aggressive) manner. The second attach request can comprise or be associated with other information, such as the device identifier, the temporary device identifier, and/or metadata (e.g., second time information, such as a second time stamp or second time indicator that can indicate the second time that the second attach request was made). The base station 112 can receive the second attach request and associated information. If no time information is yet associated with the second attach request, the base station 112 can include the second time information relating to the second attach request with the associated information. As indicated at reference numeral 216 of the attach request processing flow 200, the base station 112 can communicate the second attach request and the associated information, including the device identifier (e.g., encrypted device identifier), the temporary device identifier, and/or other metadata (e.g., the second time information associated with the second attach request), to the RIC 114 at the RAN 110.

As indicated at reference numeral 218 of the attach request processing flow 200, the SMC 116 can analyze the second attach request and the associated information, the temporary device identifier data 120 stored in the data store 122, the previous information (e.g., the time information) associated with the first attach request, and based at least in part on the results of such analysis, the SMC 116 can determine that the temporary device identifier is contained in (e.g., is part of) the temporary device identifier data 120 stored in the data store 122, can determine that this is the second attach request by the communication device 104 that is associated with the temporary device identifier, can determine that the communication device 104 has satisfied (e.g., has met; has waited) at least the defined threshold amount of time after sending the first attach request before sending the second attach request to the core network (e.g., the base station 112, RAN 110, or other network equipment), can determine that the communication device 104 is acting in a benign manner (e.g., at least with regard to the defined threshold amount of time), and can determine that the second attach attempt can be accepted (e.g., by the RAN 110 and/or core network), in accordance with the defined network security criteria. In some embodiments, the SMC 116 also can store information relating to the second attach attempt, including the second time information associated with the second attach attempt, in (e.g., with) or in association with the temporary device identifier data 120 in the data store 122.

In response to determining that the attach request is to be accepted, the SMC 116 can communicate an accept message relating to the second attach request to the base station 112 to notify the base station 112 that the second attach request has been accepted, as indicated at reference numeral 220 of the attach request processing flow 200. In some embodiments, the SMC 116 can communicate attach, registration, and/or connection instructions to the RAN 110, base station 112, and/or packet core component 118 (e.g., the AMF 124 of the packet core component 118) that can instruct that the attachment, registration, and/or connection of the communication device 104 to or with the communication network 102 can proceed. As indicated at reference numeral 222 of the attach request processing flow 200, the base station 112 can communicate the accept message relating to the second attach request to the communication device 104 to notify the communication device 104 that the second attach request has been accepted. In some embodiments, the accept message can comprise the temporary device identifier that was assigned to the communication device 104.

In certain embodiments, the SMC 116 also can communicate information relating to the second attach request to the packet core component 118 (e.g., the AMF 124 and/or another component of the packet core component 118) to facilitate (e.g., enable) the packet core component 118 to process the second attach request and attach, register, or connect the communication device 104 with the communication network 102 (unless the packet core component 118 determines, for another reason, that the communication device 104 is not to be attached, registered, or connected to the communication network 102, such as described herein).

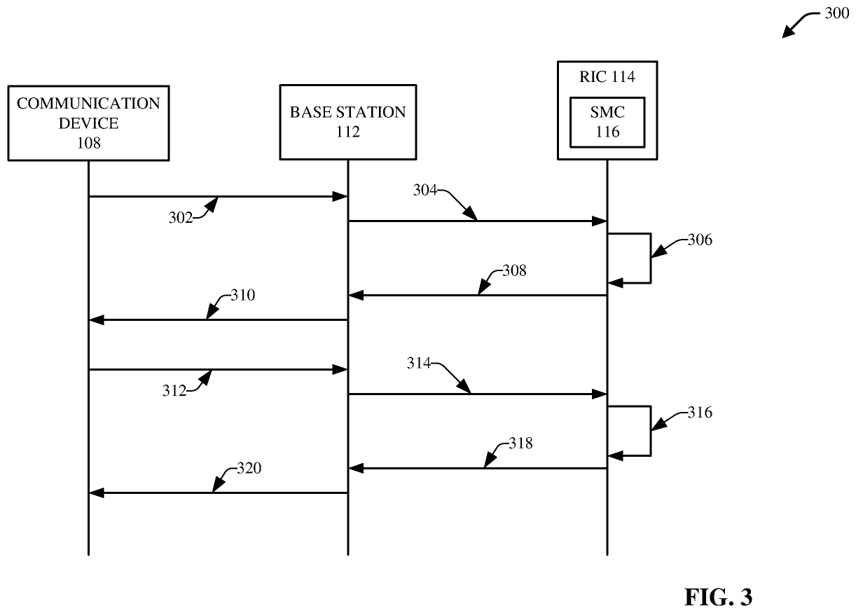

Turning to FIG. 3 (along with FIGS. 1 and 2), FIG. 3 illustrates a block diagram of an example attach request processing flow 300 relating to a communication device that can be attempting to attach, register, or connect, to or with the RAN and can be determined to be acting in an undesirably aggressive manner by the SMC, in accordance with various aspects and embodiments of the disclosed subject matter. As part of the attach request processing flow 300, a communication device 108 can communicate an attach request and associated information to the base station 112, as indicated at reference numeral 302. The attach request can comprise or be associated with other information, such as a device identifier associated with the communication device 108, a temporary device identifier that is temporarily associated with the communication device 108, and/or metadata (e.g., time information, such as a time stamp or time indicator that can indicate the time that the attach request was made), such as described herein. The base station 112 can receive the attach request and associated information.

As indicated at reference numeral 304 of the attach request processing flow 300, the base station 112 can communicate the attach request and the associated information, including the device identifier (e.g., encrypted device identifier), temporary device identifier, and/or other metadata (e.g., the time information associated with the attach request), associated with the communication device 108 to the RIC 114 at the RAN 110. As indicated at reference numeral 306 of the attach request processing flow 300, the SMC 116 can analyze the attach request and the associated information and also can analyze the temporary device identifier data 120 associated with the RAN 110 and stored in the data store 122, and based at least in part on the results of the analysis, the SMC 116 can determine that the temporary device identifier is not contained in the list of temporary device identifiers associated with benign communication devices in the temporary device identifier data 120, can determine that this is the first attach request that is associated with the temporary device identifier (associated with the communication device 108), can store the temporary device identifier and/or other information relating to the attach request in the list of temporary device identifiers associated with benign communication devices in the temporary device identifier data 120 in the data store 122, and, since this is the first attach request associated with that temporary device identifier, can determine that the attach request is to be rejected, in accordance with the defined network security criteria, as more fully described herein.

In response to determining that the attach request is to be rejected due in part to the temporary device identifier not being found in the temporary device identifier data 120 and the attach request under consideration being determined to be the first attach request by the communication device 108 that is associated with that temporary device identifier, the SMC 116 can communicate a rejection message relating to the attach request to the base station 112 to notify the base station 112 that the attach request has been rejected, as indicated at reference numeral 308 of the attach request processing flow 300. In some embodiments, the SMC 116 can communicate rejection instructions to the RAN 110, base station 112, and/or packet core component 118 that can instruct that the attachment, registration, and/or connection of the communication device 104 to or with the communication network 102 is to be rejected or blocked. As indicated at reference numeral 310 of the attach request processing flow 300, the base station 112 can communicate the rejection message relating to the attach request to the communication device 108 to notify the communication device 108 that the attach request has been rejected. In some embodiments, the rejection message can comprise the temporary device identifier that was assigned to the communication device 108 and/or other desired information.

As indicated at reference numeral 312 of the attach request processing flow 300, at a second time (e.g., a subsequent time), the communication device 108 can communicate a second attach request (e.g., a second registration or attach attempt) and associated information to the base station 112. The second attach request can comprise or be associated with other information, such as the device identifier, a second temporary device identifier, and/or metadata (e.g., second time information, such as a second time stamp or second time indicator that can indicate the second time that the second attach request was made). As can be observed, in this example instance, instead of the associated information containing the temporary device identifier that had been provided with the first attach request associated with the communication device 108, the communication device 108 included a second temporary device identifier with the second attach request, wherein the second temporary device identifier can be different (e.g., can be a different data value) than the temporary device identifier associated with the first attach request sent by the communication device 108. The base station 112 can receive the second attach request and associated information. If no time information is yet associated with the second attach request, the base station 112 can include the second time information relating to the second attach request with the associated information. As indicated at reference numeral 314 of the attach request processing flow 300, the base station 112 can communicate the second attach request and the associated information, including the device identifier (e.g., encrypted device identifier), the second temporary device identifier, and/or other metadata (e.g., the second time information associated with the second attach request), to the RIC 114.

As indicated at reference numeral 316 of the attach request processing flow 300, the SMC 116 can analyze the second attach request and the associated information (e.g., the second temporary device identifier), the temporary device identifier data 120 stored in the data store 122, and/or other desired information, and based at least in part on the results of such analysis, the SMC 116 can determine that the second temporary device identifier is not contained in (e.g., is not part of) the list of temporary device identifiers associated with benign communication devices in the temporary device identifier data 120 stored in the data store 122, can determine that this is a first attach request associated with the second temporary device identifier (which is associated with the communication device 108), can store the second temporary device identifier and/or other information relating to the second attach request in the list of temporary device identifiers associated with benign communication devices in the temporary device identifier data 120 in the data store 122, and, since this second attach request (from the communication device 108) is only the first attach request associated with the second temporary device identifier, can determine that the second attach request is to be rejected, in accordance with the defined network security criteria, as more fully described herein. That is, the SMC 116 can determine that the communication device 108 has not satisfied the defined network security criteria with regard to the accepting of attach requests, since, as far as the SMC 116 is aware from the analysis of the second temporary device identifier and the temporary device identifier data 120, this is only the first attach request associated with the second temporary device identifier, even though this is the second registration attempt (and second attach request) associated with the communication device 108. At this point, the SMC 116 can determine or assume that the communication device 108 is acting in a benign manner based on the information the SMC 116 knows about the communication device 108 at this time. In some embodiments, the SMC 116 also can store information relating to the second attach attempt, including the second time information associated with the second attach request, in (e.g., with) or in association with the list of temporary device identifiers associated with benign communication devices in the temporary device identifier data 120 in the data store 122.

In response to determining that the second attach request is to be rejected due in part to the second temporary device identifier not being found in the temporary device identifier data 120 and the second attach request under consideration being determined to be the first attach request that is associated with that second temporary device identifier (associated with the communication device 108), the SMC 116 can communicate a rejection message relating to the second attach request to the base station 112 to notify the base station 112 that the attach request has been rejected, as indicated at reference numeral 318 of the second attach request processing flow 300. In some embodiments, the SMC 116 can communicate rejection instructions to the RAN 110, base station 112, and/or packet core component 118 that can instruct that the attachment, registration, and/or connection of the communication device 104 to or with the communication network 102 is to be rejected or blocked. As indicated at reference numeral 320 of the attach request processing flow 300, the base station 112 can communicate the rejection message relating to the second attach request to the communication device 108 to notify the communication device 108 that the second attach request has been rejected. In some embodiments, the rejection message can comprise the second temporary device identifier that was assigned to the communication device 108 and/or other desired information.

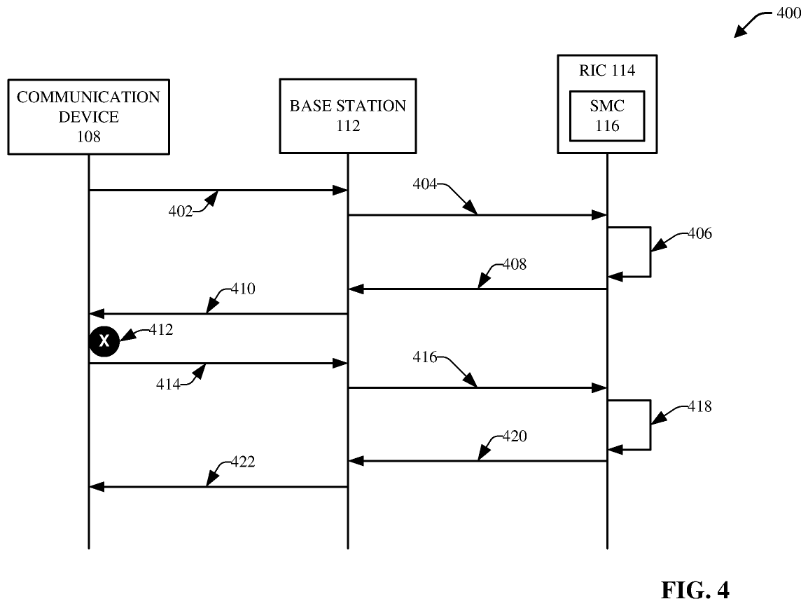

Referring to FIG. 4 (along with FIGS. 1-3), FIG. 4 depicts a block diagram of another example attach request processing flow 400 relating to a communication device that can be attempting to attach, register, or connect, to or with the RAN and can be determined to be acting in an undesirably aggressive manner by the SMC, in accordance with various aspects and embodiments of the disclosed subject matter. As part of the attach request processing flow 400, a communication device 106 can communicate an attach request and associated information to the base station 112, as indicated at reference numeral 402. The attach request can comprise or be associated with other information, such as a device identifier associated with the communication device 108, a temporary device identifier that is temporarily associated with the communication device 108, and/or metadata (e.g., time information, such as a time stamp or time indicator that can indicate the time that the attach request was made), such as described herein. The base station 112 can receive the attach request and associated information. If no time information is yet associated with the attach request, the base station 112 can include time information relating to the attach request with the associated information.

As indicated at reference numeral 404 of the attach request processing flow 400, the base station 112 can communicate the attach request and the associated information, including the device identifier (e.g., encrypted device identifier), temporary device identifier, and/or other metadata (e.g., the time information associated with the attach request), associated with the communication device 108 to the RIC 114 at the RAN 110. As indicated at reference numeral 406 of the attach request processing flow 400, the SMC 116 can analyze the attach request and the associated information and also can analyze the temporary device identifier data 120 stored in the data store 122, and based at least in part on the results of the analysis, the SMC 116 can determine that the temporary device identifier is not contained in the list of temporary device identifiers associated with benign communication devices in the temporary device identifier data 120, can determine that this is the first attach request that is associated with the temporary device identifier (associated with the communication device 108), can store the temporary device identifier and/or other information relating to the attach request in the list of temporary device identifiers associated with benign communication devices in the temporary device identifier data 120 in the data store 122, and, since this is the first attach request associated with that temporary device identifier, can determine that the attach request is to be rejected, in accordance with the defined network security criteria, as more fully described herein.

In response to determining that the attach request is to be rejected due in part to the temporary device identifier not being found in the temporary device identifier data 120 and the attach request under consideration being determined to be the first attach request by the communication device 108 that is associated with that temporary device identifier, the SMC 116 can communicate a rejection message relating to the attach request to the base station 112 to notify the base station 112 that the attach request has been rejected, as indicated at reference numeral 408 of the attach request processing flow 400. In some embodiments, the SMC 116 can communicate rejection instructions to the RAN 110, base station 112, and/or packet core component 118 that can instruct that the attachment, registration, and/or connection of the communication device 104 to or with the communication network 102 is to be rejected or blocked. As indicated at reference numeral 410 of the attach request processing flow 400, the base station 112 can communicate the rejection message relating to the attach request to the communication device 108 to notify the communication device 108 that the attach request has been rejected. In some embodiments, the rejection message can comprise the temporary device identifier that was assigned to the communication device 108 and/or other desired information.

As indicated at reference numeral 412 of the attach request processing flow 200, the SMC 116 can implement the defined threshold amount of time (e.g., as a backoff timer) and/or monitor or track the amount of time between the first attach request and a second attach request (if any) from the communication device 108 associated with the temporary device identifier, in accordance with the defined network security criteria.

As indicated at reference numeral 414 of the attach request processing flow 400, at a second time (e.g., a subsequent time), the communication device 108 can communicate a second attach request and associated information to the base station 112. In this example case of the attach request processing flow 400, the communication device 108 has not waited the defined threshold amount of time (e.g., has not waited for the backoff amount of time or backoff timer to be finished) before sending the second attach request to the base station 112 and, as a result, the communication device 108 can be acting in an undesirable (e.g., aggressive and/or malicious) manner. The second attach request can comprise or be associated with other information, such as the device identifier, the temporary device identifier, and/or metadata (e.g., second time information, such as a second time stamp or second time indicator that can indicate the second time that the second attach request was made). The base station 112 can receive the second attach request and associated information. If no time information is yet associated with the second attach request, the base station 112 can include the second time information relating to the second attach request with the associated information. As indicated at reference numeral 416 of the attach request processing flow 400, the base station 112 can communicate the second attach request and the associated information, including the device identifier (e.g., encrypted device identifier), the temporary device identifier, and/or other metadata (e.g., the second time information associated with the second attach request), to the RIC 114 at the RAN 110.

As indicated at reference numeral 418 of the attach request processing flow 400, the SMC 116 can analyze the second attach request and the associated information, the temporary device identifier data 120 stored in the data store 122, the previous information (e.g., the time information) associated with the first attach request, and based at least in part on the results of such analysis, the SMC 116 can determine that the temporary device identifier is contained in (e.g., is part of) the list of temporary device identifiers associated with benign communication devices in the temporary device identifier data 120 stored in the data store 122, can determine that this is the second attach request by the communication device 104 that is associated with the temporary device identifier, can determine that the communication device 104 has not satisfied (e.g., has not met; has not waited) at least the defined threshold amount of time after sending the first attach request before sending the second attach request to the core network (e.g., the base station 112, RAN 110, or other network equipment), can determine that the communication device 108 is acting in an aggressive manner (e.g., is exhibiting aggressive behavior at least with regard to the defined threshold amount of time), and, accordingly, can determine that the second attach attempt is to be rejected, in accordance with the defined network security criteria. In certain embodiments, the SMC 116 also can store information relating to the second attach attempt, including the second time information associated with the second attach attempt, in (e.g., with) or in association with the temporary device identifier data 120 in the data store 122. In some embodiments, in response to determining that the temporary device identifier is associated with a communication device 108 acting in an undesirably aggressive manner, the SMC 116 can remove (e.g., delete) the temporary device identifier from the benign temporary device identifier portion (e.g., the list of temporary device identifiers associated with benign communication devices) of the temporary device identifier data 120 and can store the temporary device identifier in an aggressive temporary device identifier portion (e.g., the list of temporary device identifiers associated with aggressive communication devices) of the temporary device identifier data 120. If, in the future, the RAN 110 receives any other attach requests associated with the temporary device identifier (e.g., associated with the communication device 108), the SMC 116 can determine that the temporary device identifier is contained in the aggressive temporary device identifier portion of the temporary device identifier data 120, and accordingly, can determine that the temporary device identifier is associated with an aggressive communication device 108 and can reject or block such attach request.

In response to determining that the attach request is to be rejected due in part to the temporary device identifier being determined to be associated with an aggressive communication device 108, the SMC 116 can communicate a rejection message relating to the second attach request to the base station 112 to notify the base station 112 that the second attach request has been rejected, as indicated at reference numeral 420 of the attach request processing flow 400. In some embodiments, the SMC 116 can communicate rejection instructions to the RAN 110, base station 112, and/or packet core component 118 that can instruct that the attachment, registration, and/or connection of the communication device 104 to or with the communication network 102 is to be rejected or blocked. As indicated at reference numeral 422 of the attach request processing flow 400, the base station 112 can communicate the rejection message relating to the second attach request to the communication device 108 to notify the communication device 108 that the second attach request has been rejected. In some embodiments, the rejection message can comprise the temporary device identifier that was assigned to the communication device 108 and/or other desired information.

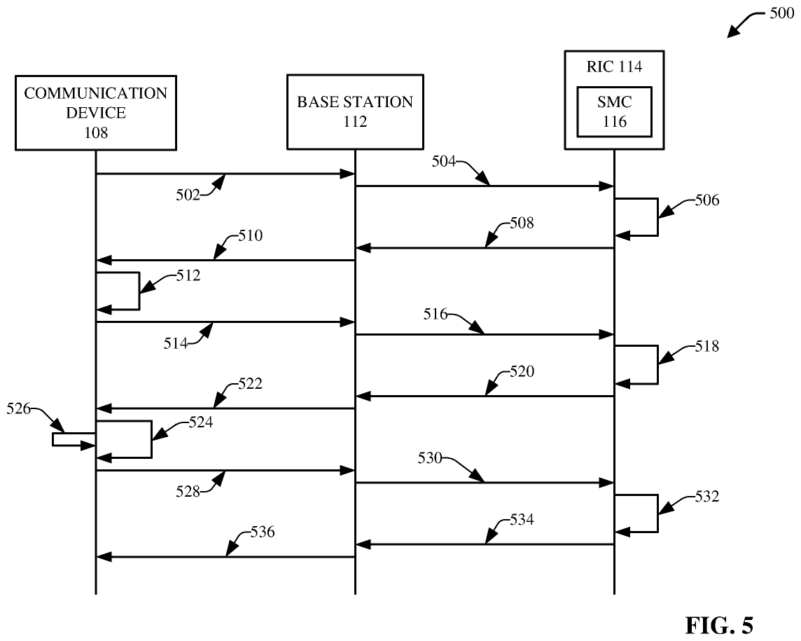

Referring to FIG. 5 (along with FIGS. 1-4), FIG. 5 illustrates a block diagram of yet another example attach request processing flow 500 relating to a communication device that can be attempting to attach, register, or connect, to or with the RAN and can be determined to be acting in an undesirably aggressive manner by the SMC, in accordance with various aspects and embodiments of the disclosed subject matter. As part of the attach request processing flow 500, a communication device 108 can communicate an attach request and associated information to the base station 112, as indicated at reference numeral 502. The attach request can comprise or be associated with other information, such as a device identifier associated with the communication device 108, a temporary device identifier that is temporarily associated with the communication device 108, and/or metadata (e.g., time information, such as a time stamp or time indicator that can indicate the time that the attach request was made), such as described herein. The base station 112 can receive the attach request and associated information.

As indicated at reference numeral 504 of the attach request processing flow 500, the base station 112 can communicate the attach request and the associated information, including the device identifier (e.g., encrypted device identifier), temporary device identifier, and/or other metadata (e.g., the time information associated with the attach request), associated with the communication device 108 to the RIC 114 at the RAN 110. As indicated at reference numeral 506 of the attach request processing flow 500, the SMC 116 can analyze the attach request and the associated information and also can analyze the temporary device identifier data 120 associated with the RAN 110 and stored in the data store 122, and based at least in part on the results of the analysis, the SMC 116 can determine that the temporary device identifier is not contained in the list of temporary device identifiers associated with benign communication devices in the temporary device identifier data 120, can determine that this is the first attach request that is associated with the temporary device identifier (associated with the communication device 108), can store the temporary device identifier and/or other information relating to the attach request in the list of temporary device identifiers associated with benign communication devices in the temporary device identifier data 120 in the data store 122, and, since this is the first attach request associated with that temporary device identifier, can determine that the attach request is to be rejected, in accordance with the defined network security criteria, as more fully described herein.

In response to determining that the attach request is to be rejected due in part to the temporary device identifier not being found in the temporary device identifier data 120 and the attach request under consideration being determined to be the first attach request by the communication device 108 that is associated with that temporary device identifier, the SMC 116 can communicate a rejection message relating to the attach request to the base station 112 to notify the base station 112 that the attach request has been rejected, as indicated at reference numeral 508 of the attach request processing flow 500. In some embodiments, the SMC 116 can communicate rejection instructions to the RAN 110, base station 112, and/or packet core component 118 that can instruct that the attachment, registration, and/or connection of the communication device 104 to or with the communication network 102 is to be rejected or blocked. As indicated at reference numeral 510 of the attach request processing flow 500, the base station 112 can communicate the rejection message relating to the attach request to the communication device 108 to notify the communication device 108 that the attach request has been rejected. In some embodiments, the rejection message can comprise the temporary device identifier that was assigned to the communication device 108 and/or other desired information.

As indicated at reference numeral 512 of the attach request processing flow 500, the SMC 116 can implement the defined threshold amount of time (e.g., as a backoff timer) and/or monitor or track the amount of time between the first attach request and a second attach request (if any) from the communication device 108 associated with the temporary device identifier, in accordance with the defined network security criteria. In this instance, the communication device 108 can fall into this wait time between attach requests based on the backoff timer.

As indicated at reference numeral 514 of the attach request processing flow 500, at a second time (e.g., a subsequent time), the communication device 108 can communicate a second attach request and associated information to the base station 112. In this example case of the attach request processing flow 500, the communication device 108 has waited the defined threshold amount of time before sending the second attach request to the base station 112 and, at least with regard to the defined threshold amount of time, the communication device 108 can be acting in a desirable benign (e.g., non-aggressive) manner here. The second attach request can comprise or be associated with other information, such as the device identifier, the temporary device identifier, and/or metadata (e.g., second time information, such as a second time stamp or second time indicator that can indicate the second time that the second attach request was made). The base station 112 can receive the second attach request and associated information. If no time information is yet associated with the second attach request, the base station 112 can include the second time information relating to the second attach request with the associated information. As indicated at reference numeral 516 of the attach request processing flow 500, the base station 112 can communicate the second attach request and the associated information, including the device identifier (e.g., encrypted device identifier), the temporary device identifier, and/or other metadata (e.g., the second time information associated with the second attach request), to the RIC 114 at the RAN 110.

As indicated at reference numeral 518 of the attach request processing flow 500, the SMC 116 can analyze the second attach request and the associated information, the temporary device identifier data 120 stored in the data store 122, the previous information (e.g., the time information) associated with the first attach request, and based at least in part on the results of such analysis, the SMC 116 can determine that the temporary device identifier is contained in (e.g., is part of) the list of temporary device identifiers associated with benign communication devices in the temporary device identifier data 120 stored in the data store 122, can determine that this is the second attach request by the communication device 108 that is associated with the temporary device identifier, can determine that the communication device 108 has satisfied the defined threshold amount of time after sending the first attach request before sending the second attach request to the core network (e.g., the base station 112, RAN 110, or other network equipment), can determine that the communication device 108 is acting in a benign manner (e.g., at least with regard to this second attach request and the defined threshold amount of time), and can determine that the second attach attempt can be accepted (e.g., by the RAN 110 and/or core network), in accordance with the defined network security criteria. In some embodiments, the SMC 116 also can store information relating to the second attach attempt, including the second time information associated with the second attach attempt, in (e.g., with) or in association with the list of temporary device identifiers associated with benign communication devices in the temporary device identifier data 120 in the data store 122.

In response to determining that the attach request is to be accepted, the SMC 116 can communicate an accept message relating to the second attach request to the base station 112 to notify the base station 112 that the second attach request has been accepted, as indicated at reference numeral 520 of the attach request processing flow 500. In some embodiments, the SMC 116 can communicate attach, registration, and/or connection instructions to the RAN 110, base station 112, and/or packet core component 118 (e.g., the AMF 124 of the packet core component 118) that can instruct that the attachment, registration, and/or connection of the communication device 104 to or with the communication network 102 can proceed. As indicated at reference numeral 522 of the attach request processing flow 500, the base station 112 can communicate the accept message relating to the second attach request to the communication device 108 to notify the communication device 108 that the second attach request has been accepted. In some embodiments, the accept message can comprise the temporary device identifier that was assigned to the communication device 108.

In certain embodiments, the SMC 116 also can communicate information relating to the second attach request to the packet core component 118 (e.g., the AMF 124 and/or another component of the packet core component 118) to facilitate (e.g., enable) the packet core component 118 to process the second attach request and attach, register, or connect the communication device 104 with the communication network 102. At this point, the communication device 108 has been determined to be exhibiting benign behavior (at least so far) and can be connected to the communication network 102.

As indicated at reference numeral 524 of the attach request processing flow 500, the SMC 116 can implement or continue to implement an applicable defined threshold amount of time (e.g., as a backoff timer) and/or monitor or track the amount of time between the second attach request and a third attach request (if any) from the communication device 108 associated with the temporary device identifier, in accordance with the defined network security criteria. In some embodiments, the applicable defined threshold amount of time can be the same length of time as was used with regard to the period of time between the first attach request and the second attach request (e.g., can be the defined threshold amount of time). In other embodiments, the applicable defined threshold amount of time applicable between the second attach request and a third attach request can be a different length of time (e.g., a longer length of time (e.g., a second defined amount of time, as described herein) or shorter length of time) than was used with regard to the period of time between the first attach request and the second attach request if and when, and as, specified by the defined network security criteria. In this example instance, the communication device 108 can fall into the wait time between attach requests based on the applicable backoff timer.

In certain embodiments, the SMC 116 can employ other time thresholds, such as, for example, the second defined threshold amount of time, a third defined threshold amount of time, and/or a fourth defined threshold amount of time. The second defined threshold amount of time can be a desired length of time (e.g., 12 minutes; greater than 12 minutes; or less than 12 minutes, but greater than the defined threshold amount of time) and can act as or can correspond to a longer backoff timer that can be applied with regard to one or more subsequent (e.g., third (or not) or fourth (or not), or other subsequent) attach requests received from a communication device (e.g., communication device 108) in instances where the communication device associated with a temporary device identifier has had multiple attach requests rejected in a relatively short amount of time (e.g., within a few minutes), wherein the communication device is supposed to back off from sending another attach request to the communication network 102 for at least the second defined threshold length of time, corresponding to the longer backoff timer. Additionally or alternatively, the SMC 116 can apply the second defined threshold length of time in instances where a communication device (e.g., 108) associated with a temporary device identifier has been allowed to attach to the communication network 102, but the communication device detaches and sends another attach request to the RAN 110 within a relatively short period of time that can be deemed an undesirable aggressive action, in accordance with the defined network security criteria. When the second defined threshold time is being applied, the SMC 116 can treat a failure of a communication device to back off and wait the second defined threshold amount of time after sending a last attach request before sending a next attach request to the communication network 102 as an undesirable aggressive action and, in response, can take a desired responsive action, such as, for example, rejecting the attach request and/or placing (e.g., storing) the temporary device identifier associated with the aggressive communication device in the aggressive temporary device identifier portion (e.g., the list of temporary device identifiers associated with aggressive communication devices) of the temporary device identifier data 120.

The third defined amount of time can relate to an amount of time that the SMC 116 can continue to retain (e.g., store) the temporary device identifier associated with a communication device (e.g., communication device 104) in the benign temporary device identifier portion (e.g., the list of temporary device identifiers associated with benign communication devices) of the temporary device identifier data 120. In some embodiments, the third defined amount of time can be longer the second defined threshold amount of time, which can enable the SMC 116 to identify aggressive communication devices that may initially appear to be acting in a benign manner and are able to connect to the communication network 102, but then detach from the communication network 102 and send another attach request(s) to the communication network 102 in a relatively short amount of time after detaching (but longer than the defined threshold amount of time) to attempt to register and attach with the communication network 102. The third defined amount of time can be, for example, 15 minutes or another desired time that can be greater than 15 minutes or less than 15 minutes, but longer than the second defined threshold amount of time. The SMC 116 (or another component of the system 100) can configure the third defined amount of time to be desirably long enough (e.g., longer than the second defined threshold amount of time) to enable the SMC 116 to detect certain aggressive communication devices that are attaching, detaching, and attempting to attach again in an undesirably aggressive manner, while also enabling the SMC 116 to maintain (e.g., store) a desirably small number of temporary device identifiers (and/or other associated information) in the benign temporary device identifier portion (e.g., a list of temporary device identifiers associated with benign communication devices) of the temporary device identifier data 120, so that there are not too many communication devices represented in the list of temporary device identifiers associated with benign communication devices.

The fourth defined amount of time can relate to an amount of time that the SMC 116 can continue to retain the temporary device identifier associated with an aggressive communication device (e.g., the communication device 108) in the aggressive temporary device identifier portion (e.g., a list of temporary device identifiers associated with aggressive communication devices) of the temporary device identifier data 120. In certain embodiments, the fourth defined amount of time can be longer the third defined threshold amount of time, which can enable the SMC 116 to identify (e.g., quickly identify or detect) aggressive communication devices that may continue to send (e.g., aggressively send) one or more attach requests to the communication network 102 over a relatively short time period, for example, to cause the communication network 102 to undesirably utilize resources to process such attach requests and/or to become overwhelmed by such aggressive attach attempts (and/or by aggressive signaling by other aggressive communication devices), which can result in the communication network 102, or portion thereof (e.g., RAN 110), not being able to provide desired resources and communication services to other devices (e.g., benign communication devices). The fourth defined amount of time can be, for example, 60 minutes or another desired time that can be greater than 60 minutes or less than 60 minutes, but typically longer than the third defined threshold amount of time. The SMC 116 (or another component of the system 100) can configure the fourth defined amount of time to be desirably long enough (e.g., longer than the third defined threshold amount of time) to enable the SMC 116 to desirably (e.g., efficiently, quickly, enhancedly, or optimally) detect certain aggressive communication devices that are attaching, detaching, and attempting to attach again in an undesirably aggressive manner (or engaging in other undesired aggressive behavior), while also enabling the SMC 116 to maintain (e.g., store) a desirably small number of temporary device identifiers (and/or other associated information) in the aggressive temporary device identifier portion (e.g., the list of temporary device identifiers associated with aggressive communication devices) of the temporary device identifier data 120, so that the number of communication devices represented in the list of temporary device identifiers associated with aggressive communication devices does not become too large and continue to have temporary device identifiers associated with communication devices that may longer present a threat of being aggressive against the communication network 102.

With further regard to the attach request processing flow 500, at some point before the defined threshold amount of time (or the second defined threshold amount of time, whichever is applicable) has been satisfied (e.g., has elapsed), the communication device 108 can detach from the communication network 102, as indicated at reference numeral 526 of the attach request processing flow 500. For instance, the communication device 108 can communicate a detach message to the communication network 102, via the base station 112 and RAN 110, to request to detach from the communication network 102 or can take other action to detach from the communication network 102. In response, the communication network 102 (e.g., the packet core component 118 of the communication network 102) can detach the communication device 108 from the communication network 102.

Subsequently, at a third time that is after the defined threshold amount of time being satisfied (e.g., elapsing) (or before the defined threshold amount of time has been satisfied), the communication device 108 can communicate a third attach request and associated information to the base station 112, as indicated at reference numeral 528 of the attach request processing flow 500. In this example case of the attach request processing flow 500, even if the communication device 108 waited the defined threshold amount of time after sending the second attach request before sending the third attach request to the base station 112 (e.g., but has not waited at least the applicable (e.g., second) defined threshold amount of time before doing so), the SMC 116 can determine that the communication device 108 is engaging in undesirably aggressive behavior by detaching and attempting to reattach in such a relatively short amount of time. The third attach request can comprise or be associated with other information, such as the device identifier, the temporary device identifier, and/or metadata (e.g., third time information, such as a third time stamp or third time indicator that can indicate the third time that the third attach request was made). The base station 112 can receive the third attach request and associated information. If no time information is yet associated with the third attach request, the base station 112 can include the third time information relating to the third attach request with the associated information. As indicated at reference numeral 530 of the attach request processing flow 500, the base station 112 can communicate the third attach request and the associated information, including the device identifier (e.g., encrypted device identifier), the temporary device identifier, and/or other metadata (e.g., the third time information associated with the third attach request), to the RIC 114 at the RAN 110.

As indicated at reference numeral 532 of the attach request processing flow 500, the SMC 116 can analyze the third attach request and the associated information, the temporary device identifier data 120 (e.g., list of temporary device identifiers associated with devices determined to be benign) stored in the data store 122, the previous information (e.g., the time information and/or the second time information) associated with the first attach request and/or the second attach request, and based at least in part on the results of such analysis, the SMC 116 can determine that the temporary device identifier is contained in (e.g., is part of) the list of temporary device identifiers associated with benign communication devices in the temporary device identifier data 120 stored in the data store 122, can determine that this is the third attach request by the communication device 108 that is associated with the temporary device identifier, can determine that the communication device 108 has satisfied the defined threshold amount of time after sending the second attach request before sending the third attach request to the core network (e.g., the base station 112, RAN 110, or other network equipment), but also can determine that the communication device 108 is now attempting to reattach to the network 102 after only a relatively short time after detaching from the network 102; and accordingly, the SMC 116 can determine that the communication device 108 is acting in an undesirably aggressive manner (even though the communication device 108 may (or may not) have waited the defined threshold amount of time before sending the third attach request), and can determine that the third attach attempt is to be rejected, in accordance with the defined network security criteria. In some embodiments, the SMC 116 also can store information relating to the third attach attempt, including the third time information associated with the third attach attempt, in (e.g., with) or in association with the temporary device identifier data 120 in the data store 122.

In some embodiments, in response to determining that the temporary device identifier is associated with a communication device 108 acting in an undesirably aggressive manner, the SMC 116 can remove (e.g., delete) the temporary device identifier (and/or the associated information) from the benign temporary device identifier portion (e.g., the list of temporary device identifiers associated with benign communication devices) of the temporary device identifier data 120 and can store the temporary device identifier (and/or the associated information) in the aggressive temporary device identifier portion (e.g., the list of temporary device identifiers associated with aggressive communication devices) of the temporary device identifier data 120. If, in the future, the RAN 110 receives any other attach requests associated with the temporary device identifier (e.g., associated with the communication device 108), the SMC 116 can desirably (e.g., quickly, efficiently, enhancedly, or optimally) determine or detect that the temporary device identifier is contained in the aggressive temporary device identifier portion of the temporary device identifier data 120, and accordingly, can desirably determine that the temporary device identifier is associated with an aggressive communication device 108 and can reject or block such attach request.

In response to determining that the attach request is to be rejected due in part to the temporary device identifier being determined to be associated with an aggressive communication device 108, the SMC 116 can communicate a rejection message relating to the second attach request to the base station 112 to notify the base station 112 that the third attach request has been rejected, as indicated at reference numeral 534 of the attach request processing flow 500. In some embodiments, the SMC 116 can communicate rejection instructions to the RAN 110, base station 112, and/or packet core component 118 that can instruct that the attachment, registration, and/or connection of the communication device 104 to or with the communication network 102 is to be rejected or blocked. As indicated at reference numeral 536 of the attach request processing flow 500, the base station 112 can communicate the rejection message relating to the third attach request to the communication device 108 to notify the communication device 108 that the third attach request has been rejected. In some embodiments, the rejection message can comprise the temporary device identifier that was assigned to the communication device 108 and/or other desired information.

With further regard to the packet core component 118, the packet core component 118 can comprise the AMF component 124, a session management function (SMF) component 126, a user plane function (UPF) component 128, an authentication server function (AUSF) component 130, a policy control function (PCF) component 132, a unified data repository (UDR) component 134, and/or other components that can be respectively associated with each other (e.g., respectively connected or interfaced with each other).

The AMF component 124 can comprise an access and mobility function, wherein the AMF component 124 can perform mobility management functions, connection management functions, authentication functions, access authorization, location-related services management, and/or other functions in connection with authenticating a communication device (e.g., 104, 106, or 108) and/or associated user, granting the communication device (e.g., an authenticated or authorized communication device) access to the core network and associated services, establishing and managing a communication connection (e.g., a mobile or wireless communication connection) for the communication device with the core network, providing location-based services to the communication device, and/or performing other functions for the communication device.

The SMF component 126 can perform session management functions (e.g., establishment, modification, and release) for communication sessions involving communication devices (e.g., 104, 106, and/or 108). The SMF component 126 also can facilitate determining or selecting UPFs to be used for communication sessions involving the communication devices.

The UPF component 128 can be part of the user plane, which also can comprise one or more communication devices (e.g., UEs), such as communication devices 104, 106, and/or 108, and the RAN 110. The UPF component 128 can comprise a user plane function that can provide or facilitate providing policy enforcement in the user plane, routing and forwarding of data packets in the core network, inspection of data packets, quality of service (QoS) management and enforcement in the core network, downlink buffering of data packets, and/or other functions. The UPF component 128 also can act or operate as an external protocol data unit (PDU) session point of interconnect to a data network (DN) component (not shown in FIG. 1), which also can be part of the user plane. The UPF component 128 further can be an anchor point for intra- and inter-RAT mobility.

The AUSF component 130 can comprise an authentication server function, wherein the AUSF component 130 can comprise an authentication server that can perform authentication functions to facilitate authenticating communication devices (e.g., 104, 106, and/or 108), and can store authentication data that can be utilized to facilitate authenticating the communication devices.

The PCF component 132 can comprise and implement a policy control function that can support a unified policy framework for the core network, can facilitate policy control for the core network, and can apply desired (e.g., appropriate, suitable, or applicable) policies, including providing desired policy rules to other functions (e.g., functions of the AUSF component 130, AMF component 124, or other component) of the control plane to facilitate application and enforcement of the desired policy rules.

The UDR component 134 can store data relating to users (e.g., subscribers), application-related data, policy data, and/or other data. The UDR component 134 can store desired (e.g., useful, wanted, or pertinent) data, including structured data (e.g., data structured in a desired format), that can be made available to or accessed by one or more network functions, such as, for example, the AMF component 124 or SMF component 126.

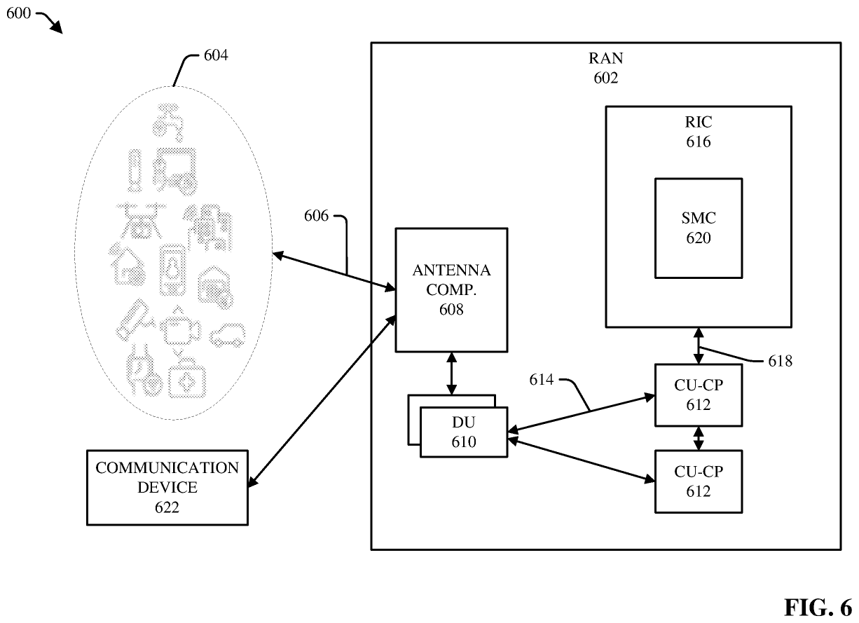

Referring to FIG. 6, FIG. 6 depicts a diagram of an example system 600 comprising a RAN to which communication devices, including IoT devices, are attempting to connect or are already connected, wherein the RAN comprises an SMC that can detect and mitigate aggressive and/or malicious events against the RAN by aggressive and/or malicious communication devices and can manage attachment, registration, or connection of communication devices to the RAN or associated communication network, in accordance with various aspects and embodiments of the disclosed subject matter. The system 600 can comprise a RAN 602 that can be part of a communication network (e.g., a mobility core network of a communication network). The RAN 602 can be the same as, or can comprise the same or similar functionality as, RANs, such as more fully described herein.

In an example instance, a plurality of communication devices 604, including IoT devices, can be attempting to connect (e.g., wirelessly connect) to the RAN 602 (or some of those devices may already be connected to the RAN 602) as part of an aggressive and/or malicious event (e.g., malicious attack, signaling storm, and/or other aggressive action) by those communication devices 604 against the RAN 602. For instance, the plurality of communication devices 604 can be compromised communication devices (e.g., compromised massive IoT) that can be infected with malware. In some embodiments, each of the plurality of communication devices 604 can communicate respective attach requests or other communications to the RAN 602 via an air interface (depicted at reference numeral 606) associated with the RAN 602 to an antenna component 608 of the RAN 602. In some embodiments, the antenna component 608 can comprise a MIMO antenna array and radio unit to facilitate receiving of information by the RAN 602 and transmitting of information from the RAN 602.

The RAN 602 also can include a distributed unit (DU) component 610 that can comprise a DU function that can be associated with the radio unit and associated antenna component 608. The DU function in the 5G gNodeB/NR framework can comprise some of the functions that the base band unit (BBU) of 4G/LTE has.

The RAN 602 also can comprise a central unit-control plane (CU-CP) component 612 that can employ a CU-CP function in the 5G gNodeB/NR framework. The CU-CP function can comprise certain functions (e.g., functions different from the DU function) that the BBU of 4G/LTE has. The DU component 610 can be associated with (e.g., communicatively connected to) the CU-CP component 612 via an F1-C interface 614 to facilitate data flows between the DU component 610 and the CU-CP component 612.

The RAN 602 further can comprise a RIC 616 that can be associated with (e.g., communicatively connected to) the CU-CP component 612 via an E2 interface 618, wherein the E2 interface can facilitate data flows between the CU-CP component 612 and the RIC 616. The RIC 616 can manage various functions and resources of the RAN 602 in real time or substantially close (e.g., near) to real time.

The RAN 602 can comprise an SMC 620 that can detect and mitigate aggressive and/or malicious events by certain communication devices (e.g., plurality of communication devices 604) against the RAN 602, and desirably managing connections of communication devices to the RAN 602 during an aggressive and/or malicious event to desirably (e.g., suitably, efficiently, and/or optimally) reject or block attach requests by aggressive and/or malicious communication devices, such as, for example, the plurality of communication devices 604 while allowing or enabling non-aggressive (e.g., benign) communication devices, such as, for example, communication device 622, to attach, connect, and/or register to or with the communication network, in accordance with the defined network security criteria. In some embodiments, the SMC 620 can comprise and employ a security application (e.g., an aggressive and/or malicious event, DDoS, and/or throttling application) to facilitate detecting and mitigating aggressive and/or malicious events against the RAN 602, and managing connections of communication devices to the RAN 602. In some embodiments, the security application can be a micro services application (e.g., xApp). The SMC 620 can be the same as, or can comprise the same or similar functionality as, the SMCs, as more fully described herein.

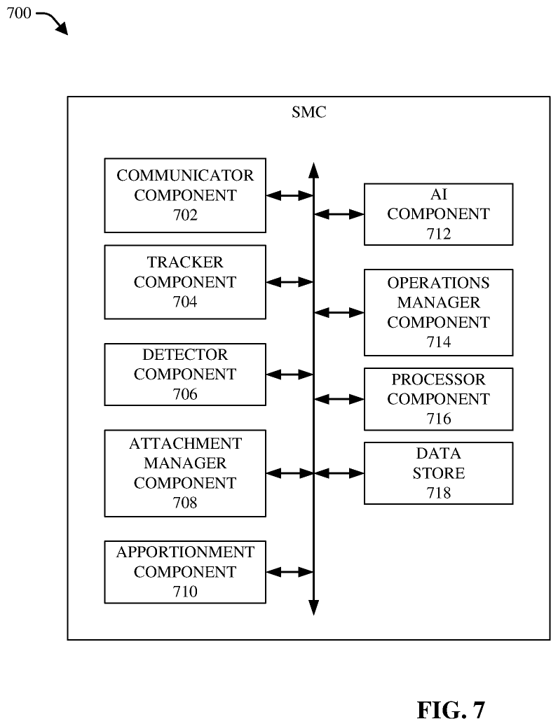

Referring to FIG. 7, FIG. 7 depicts a block diagram of an example SMC 700, in accordance with various aspects and embodiments of the disclosed subject matter. The SMC 700 can comprise a communicator component 702, a tracker component 704, a detector component 706, an attachment manager component 708, an apportionment component 710, an AI component 712, an operations manager component 714, a processor component 716, and a data store 718.

The communicator component 702 can transmit information to other components or devices, and can receive information from other components or devices. For example, the communicator component 702 can transmit messages, signals, and/or data relating to accepting or rejecting attach requests associated with communication devices to communication devices (e.g., communication devices that sent attach requests to the RAN), network equipment (e.g., base stations), or other components or devices to facilitate notifying or advising whether the attach requests have been accepted or rejected. As another example, the communicator component 702 also can receive messages, signals, and/or data relating to attach requests, device identifiers, temporary device identifiers, time information (e.g., time an attach request was sent), location (e.g., geographical location), and/or metadata associated with communication devices.

The tracker component 704 can monitor and track various types of information, actions, events, time events, messages, signals, and/or data. For example, the tracker component 704 can monitor and track attach requests received from communication devices, including monitoring and tracking a number of attach requests received from a communication device (e.g., overall, or over a given period of time), temporary device identifiers associated with communication devices, a time (e.g., sending time) that an attach request was sent by a communication device, an amount of time between the sending of attach requests by a communication device associated with a temporary device identifier, applicable threshold amounts of time or backoff timers relating to attach events, attach events associated with a communication device, detach events associated with a communication device, and/or other desired types of information, actions, events, time events, messages, signals, and/or data. The SMC 700 can utilize the information, actions, events, time events, messages, signals, and/or data tracked by the tracker component to facilitate determining whether to accept or reject an attach request (or other type of request) associated with a temporary device identifier and/or associated communication device, determining whether a communication device associated with a temporary device identifier is exhibiting aggressive and/or malicious behavior, and/or other determinations relating to managing the attaching, registering, or connecting of communication devices to or with the communication network and/or managing resources of or associated with the communication network, in accordance with the defined network security criteria.

The detector component 706 can analyze information relating to attach requests (or other types of requests or actions) associated with temporary device identifiers associated with communication devices and temporary device identifier data associated with the RAN. Based at least in part on the results of such analysis, the detector component 706 can determine or detect whether a communication device(s) associated with a temporary device identifier(s) is acting in an undesirably aggressive and/or malicious manner. For instance, based at least in part on the results of such analysis, with regard to a communication device associated with a temporary device identifier, the detector component 706 can determine whether an attach request is a first attach request or a subsequent (e.g., second, third, or other subsequent) attach request associated with the temporary device identifier, and if the attach request is a subsequent attach request, can determine whether the communication device waited the applicable threshold amount of time after sending the first (or previous) attach request before sending the current subsequent attach request, and/or can determine whether the communication device is attempting to attach to the communication network again after recently detaching from the communication network. If the detector component 706 determines that the attach request is only the first attach request associated with the temporary device identifier, the detector component 706 can determine that the communication device is not acting, or at least appears to not be acting, in an aggressive and/or malicious manner. If the detector component 706 determines that the attach request is a subsequent attach request associated with the temporary device identifier and the communication device did not wait the applicable threshold amount of time after sending the first (or previous) attach request before sending the current subsequent attach request, the detector component 706 can determine or detect that the communication device is acting in an aggressive and/or malicious manner. If the detector component 706 determines the communication device is attempting to attach to the communication network again after recently being attached to and detaching from the communication network such that an applicable threshold amount of time has not been satisfied (e.g., met) (such as more fully described herein), the detector component 706 can determine or detect that the communication device is acting in an aggressive and/or malicious manner.

The attachment manager component 708 can manage the accepting (e.g., granting) or rejecting of attach requests associated with temporary device identifiers and associated communication devices based at least in part on whether the attach requests associated with temporary device identifiers are determined to be associated with aggressive communication devices or benign communication devices, and/or whether a particular attach request is determined to be a first attach request associated with a particular temporary device identifier, in accordance with the defined network security criteria. For instance, in response to determining that an attach request associated with a temporary device identifier and associated communication device is a first attach request, the attachment manager component 708 can reject or block the attach request associated with the temporary device identifier and associated communication device. In response to rejecting the attach request, the attachment manager component 708 can facilitate communicating (e.g., via the communicator component 702) a reject message to the communication device, via the base station, to notify the communication device that the attach request has been rejected or blocked.

As another example, in response to determining that an attach request (or other type of request) is associated with a temporary device identifier that is associated with a communication device determined to be acting in an aggressive and/or malicious manner, the attachment manager component 708 can reject or block the attach request (or other type of request) associated with the temporary device identifier and associated communication device. The attachment manager component 708 also can facilitate communicating (e.g., via the communicator component 702) a reject message to the communication device, via the base station, to notify the communication device that the attach request has been rejected. As still another example, in response to determining that an attach request (or other type of request) is associated with a temporary device identifier that is associated with a communication device that has not been identified as acting in an aggressive and/or malicious manner, the attachment manager component 708 can accept or grant the attach request (or other type of request) associated with the temporary device identifier and associated communication device. The attachment manager component 708 also can facilitate communicating (e.g., via the communicator component 702) an accept message to the communication device, via the base station, to notify the communication device that the attach request (or other type of request) has been accepted or approved.

In some embodiments, in response to determining that an attach request associated with a temporary device identifier associated with a communication device is to be rejected, the attachment manager component 708 can generate rejection instructions that can be communicated to one or more desired components of the RAN (e.g., the CU-CP component or other component of the RAN). In response to the rejection instructions, the RAN (e.g., the CU-CP component or other component of the RAN) can reject or block, or facilitate rejecting or blocking, the communication device from attaching or connecting to the RAN. In response to determining that an attach request associated with a temporary device identifier associated with a communication device is to be accepted, the attachment manager component 708 can generate accept instructions that can be communicated to one or more desired components of the RAN (e.g., the CU-CP component or other component of the RAN). In response to the accept instructions, the RAN (e.g., the CU-CP component or other component of the RAN) can attach or connect, or facilitate connecting or attaching, the communication device to the RAN, and/or can forward the attach request and/or associated information to the packet core component for further processing to enable the communication device to attach, register, or connect to or with the communication network.

The attachment manager component 708 also can manage, modify, update, and/or maintain the temporary device identifier data comprising or relating to temporary device identifiers and other information associated with communication devices and attach requests (or other types of requests, signaling, or actions) associated with communication devices. For instance, the attachment manager component 708 can add a temporary device identifier associated with a communication device, which has not been determined to be aggressive, to the benign temporary device identifier portion (e.g., the list of temporary device identifiers associated with benign communication devices) of the device identifier data. The attachment manager component 708 also can remove a temporary device identifier associated with a communication device, which has been determined to be aggressive, from the benign temporary device identifier portion of the device identifier data (if the temporary device identifier was stored in the benign temporary device identifier portion of the device identifier data), and/or can add the temporary device identifier associated with the communication device to the aggressive temporary device identifier portion (e.g., the list of temporary device identifiers associated with aggressive communication devices) of the device identifier data. The attachment manager component 708 also can apply respective applicable threshold amounts of time to the list of temporary device identifiers associated with benign communication devices and the list of temporary device identifiers associated with aggressive communication devices to remove respective temporary device identifiers and/or respective associated information from the benign list and the aggressive list after the respective applicable threshold amounts of time have been determined to have been satisfied (e.g., elapsed or met) with respect to the respective temporary device identifiers.

The apportionment component 710 can apportion or allocate attach requests associated with temporary device identifiers associated with communication devices (e.g., over a given period of time) for analysis by the SMC 700 to determine or detect whether communication devices are acting in an aggressive manner or are acting in a benign manner or, instead, for further processing by the packet network component without such analysis being performed by the SMC 700. For instance, the SMC 700 (e.g., via the communicator component 702) can receive respective attach requests (e.g., attach or registration requests) and/or associated information (e.g., temporary device identifiers, device identifiers, time information, and/or other associated information) from respective communication devices associated with temporary device identifiers via one or more base stations associated with the RAN, for example, over a given time period. For instance, the one or more base stations can receive the respective attach requests and/or associated information from the respective communication devices when the respective communication devices attempt and desire to attach or register to or with the RAN. The one or more base stations can communicate the respective attach requests, associated respective temporary device identifiers, and/or other associated information to the SMC 700 of or associated with the RAN for further processing.

The apportionment component 710 can apportion or allocate a first portion of the attach requests (e.g., first attach requests or any type of attach requests) for aggressive device detection analysis by the SMC 700 and a second portion of the attach requests for forwarding to the packet core component for processing without the aggressive device detection analysis being performed by the SMC 700. In accordance with various embodiments, the first portion of the attach requests can be a first number or first percentage of the attach requests, and the second portion of the attach requests can be a second number or second percentage of the attach requests. In some embodiments, the first number of first percentage of attach request can be higher or greater than the second number or second percentage of attach requests, although, if and as desired, in other embodiments, the first number of first percentage of attach request can be lower or less than the second number or second percentage of attach requests. For instance, the apportionment component 710 can apportion or allocate the first portion of attach requests, which can comprise a desired percentage (e.g., 70% or a percentage that is greater than 70% or a percentage that is less than 70%) of the attach requests, to undergo an aggressive device detection analysis by the SMC 700, and can apportion or allocate the second portion (e.g., a remaining portion) of attach requests, which can comprise a desired percentage (e.g., 30% or a percentage that is less than 30% or a percentage that is greater than 30%) of the attach requests, to be forwarded to the packet core component for further processing without undergoing an aggressive device detection analysis by the SMC 700, in accordance with the defined network security criteria.

The SMC 700 can perform an aggressive device detection analysis on the first attach requests and/or associated information, such as more fully described herein. The apportionment component 710 can forward (e.g., send or communicate) or facilitate forwarding (e.g., via the communicator component 702) the second portion of attach requests and/or associated information to the packet core component for further processing without the second portion of attach requests undergoing an aggressive device detection analysis by the SMC 700.

The SMC 700 can employ the apportionment component 710 and apportioning of attach requests, for example, to support situations where the signaling storm or potential for a signaling storm by aggressive or potentially aggressive communication devices is determined or predicted by the SMC 700 (or a user) to not be unduly severe (e.g., not too severe or not overly severe), and, as a result, a more subtle approach or solution (e.g., apportioning of attach requests) can be applied, instead of performing an aggressive device detection analysis on all attach requests by the SMC 700, to still desirably mitigate any negative impact on the communication network that may be caused by aggressive or excessive signaling by aggressive communication devices while also desirably (e.g., suitably, enhancedly, or optimally) managing resources (e.g., computing resources, communication resources, time resources, or other resources) of or associated with the communication network to not unduly utilize (e.g., to not over-utilize or unnecessarily utilize) the resources of or associated with the communication network for aggressive device detection analysis by the SMC 700 when the aggressive or excessive signaling threat is determined or predicted to not be unduly severe. For example, if the verification procedure (e.g., where all first attach request attempts can be rejected) of the aggressive device detection analysis to only 70% of the attach requests, three out of 10 attach requests (e.g., 30% of attach requests) can go through to the packet core component without undergoing the aggressive device detection analysis by the SMC 700. Some of the attach requests of the second portion (e.g., 30%) of attach requests are likely to be benign attach requests and can be expected to establish connection of the associated communication devices to the communication network. Some attach requests associated with aggressive (e.g., rogue or malicious) communication devices also may (or may not) be part of the second portion of attach requests that get through to the packet core component without undergoing the aggressive device detection analysis by the SMC 700. These aggressive communication devices (if any) associated with the second portion of attach requests are likely to attempt core registration with the communication network, and then launch subsequent attach attempts. In this scenario, statistically, 70% of the attach request attempts by aggressive communication devices will be rejected or blocked by the SMC 700, while benign communication devices can successfully complete their attach to the communication network after, at most, two attach request attempts. Thus, the apportionment component 710, by desirably apportioning attach requests, as described herein, can enable the SMC 700 to desirably (e.g., beneficially, suitably, enhancedly, or optimally) detect aggressive communication devices and mitigate any negative impact on the communication network by such aggressive communication devices while also desirably (e.g., beneficially, suitably, enhancedly, or optimally) managing the use of resources of or associated with the communication network.

The AI component 712 can perform an AI and/or machine learning (ML) analysis on data, such as attach requests (or other types of requests) and associated information (e.g., temporary device identifiers, time information, device location data, metadata, and/or other information), historical information relating to previous attach requests (or other types of requests), and/or other desired data. In connection with or as part of such an AI or ML analysis, the AI component 712 can employ, build (e.g., construct or create), and/or import, AI and/or ML techniques and algorithms, AI and/or ML models, neural networks (e.g., trained neural networks), and/or graph mining to render and/or generate predictions, inferences, calculations, prognostications, estimates, derivations, forecasts, detections, and/or computations that can facilitate determining or detecting whether a communication device is exhibiting undesirably aggressive behavior; determining whether to accept or reject an attach request (or other type of request) associated with a temporary device identifier and associated communication device; determining whether attach, detach, and reattach events and associated attach and detach requests associated with a temporary device identifier and associated communication device indicate or involve the communication device exhibiting undesirably aggressive behavior; determining or modifying an apportioning or allocation of attach requests where a first portion of the attach requests can undergo an aggressive device detection analysis by the SMC 700 and a second portion does not and is forwarded to the packet core component for further processing; determining or modifying respective defined threshold amounts of time, such as the various types of threshold amounts of time described herein; determining mitigation or responsive actions to perform, for example, in response to aggressive and/or malicious events by aggressive and/or malicious communication devices; making other desired determinations, such as the determinations described herein; and/or automating one or more functions or features of the disclosed subject matter, as more fully described herein.

The AI component 712 can employ various AI-based or machine learning (ML)-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 712 can examine the entirety or a subset of the data (e.g., data in or associated with attach requests or other signals, data stored in the temporary device identifier data, or other data) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

The operations manager component 714 can control (e.g., manage) operations associated with the SMC 700. For example, the operations manager component 714 can facilitate generating instructions to have components of the SMC 700 perform operations, and can communicate respective instructions to respective components (e.g., communicator component 702, tracker component 704, detector component 706, attachment manager component 708, apportionment component 710, AI component 712, processor component 716, and data store 718) of the SMC 700 to facilitate performance of operations by the respective components of the SMC 700 based at least in part on the instructions, in accordance with the defined network security criteria and network security algorithms (e.g., attach request (or other type of request or signaling) management or processing algorithms, aggressive device detection or determination algorithms, aggressive device mitigation algorithms, AI or machine learning algorithms, attachment management algorithms, attach request apportionment algorithms, or other algorithms, as disclosed, defined, recited, or indicated herein by the methods, systems, and techniques described herein). The operations manager component 714 also can facilitate controlling data flow between the respective components of the SMC 700 and controlling data flow between the SMC 700 and another component(s) or device(s) (e.g., a communication device, a base station or other network component or device of the communication network, data sources, applications, or other type of component or device) associated with (e.g., connected to) the SMC 700.

The processor component 716 can work in conjunction with the other components (e.g., communicator component 702, tracker component 704, detector component 706, attachment manager component 708, apportionment component 710, AI component 712, operations manager component 714, and data store 718) to facilitate performing the various functions of the SMC 700. The processor component 716 can employ one or more processors, microprocessors, or controllers that can process data, such as information relating to communication devices, attach requests or other types of requests, device identifiers or temporary device identifiers associated with communication devices, authentication credentials associated with communication devices, network conditions, metadata, messages, aggressive or malicious communication device determinations, aggressive or malicious events, aggressive or malicious event determinations, attach management determinations, mitigation or responsive actions, parameters, threshold values (e.g., threshold amounts of time), traffic flows, policies, defined network security criteria, algorithms (e.g., attach request (or other type of request) management or processing algorithms, aggressive device detection or determination algorithms, aggressive device mitigation algorithms, AI or machine learning algorithms, attachment management algorithms, attach request apportionment algorithms, or other algorithms), protocols, interfaces, tools, and/or other information, to facilitate operation of the SMC 700, as more fully disclosed herein, and control data flow between the SMC 700 and other components (e.g., a communication device, a base station or other network component or device of the communication network, data sources, applications, or other type of component or device) associated with the SMC 700.

The data store 718 can store data structures (e.g., user data, metadata), code structure(s) (e.g., modules, objects, hashes, classes, procedures) or instructions, information relating to communication devices, attach requests or other types of requests, device identifiers or temporary device identifiers associated with communication devices, authentication credentials associated with communication devices, network conditions, metadata, messages, aggressive or malicious communication device determinations, aggressive or malicious events, aggressive or malicious event determinations, attach management determinations, mitigation or responsive actions, parameters, threshold values (e.g., threshold amounts of time), traffic flows, policies, defined network security criteria, algorithms (e.g., attach request (or other type of request) management or processing algorithms, aggressive device detection or determination algorithms, aggressive device mitigation algorithms, AI or machine learning algorithms, attachment management algorithms, attach request apportionment algorithms, or other algorithms), protocols, interfaces, tools, and/or other information, to facilitate controlling operations associated with the SMC 700. In an aspect, the processor component 716 can be functionally coupled (e.g., through a memory bus) to the data store 718 in order to store and retrieve information desired to operate and/or confer functionality, at least in part, to the communicator component 702, tracker component 704, detector component 706, attachment manager component 708, apportionment component 710, AI component 712, operations manager component 714, processor component 716, data store 718, or other component, and/or substantially any other operational aspects of the SMC 700.

Described herein are systems, methods, articles of manufacture, and other embodiments or implementations that can facilitate detecting and mitigating aggressive and/or malicious communication devices, and associated aggressive and/or malicious events, against a RAN of a communication network, and managing attachment, registration, or connection of communication devices to the RAN or communication network, as more fully described herein. The detecting and mitigating of aggressive and/or malicious communication devices, and associated aggressive and/or malicious events against a RAN and/or communication network, managing of attachment, registration, or connection of communication devices to the RAN or communication network, and/or other features of the disclosed subject matter, can be implemented in connection with any type of device with a connection to, or attempting to connect to, the communication network (e.g., a wireless or mobile device, a computer, a handheld device, or other device), any Internet of things (IoT) device (e.g., health monitoring device, toaster, coffee maker, blinds, music players, speakers, or other IoT device), and/or any connected vehicles (e.g., cars, airplanes, space rockets, and/or other at least partially automated vehicles (e.g., drones)). In some embodiments, the non-limiting term user equipment (UE) is used. It can refer to any type of wireless device that communicates with a radio network node in a cellular or mobile communication system. Examples of UE can be a target device, device to device (D2D) UE, machine type UE or UE capable of machine to machine (M2M) communication, PDA, Tablet, mobile terminals, smart phone, Laptop Embedded Equipped (LEE), laptop mounted equipment (LME), USB dongles, or other type of device. Note that the terms element, elements and antenna ports can be interchangeably used but carry the same meaning in this disclosure. The embodiments are applicable to single carrier as well as to Multi-Carrier (MC) or Carrier Aggregation (CA) operation of the UE. The term Carrier Aggregation (CA) is also called (e.g., interchangeably called) “multi-carrier system,” “multi-cell operation,” “multi-carrier operation,” “multi-carrier” transmission and/or reception.

In some embodiments, the non-limiting term radio network node or simply network node is used. It can refer to any type of network node that serves one or more UEs and/or that is coupled to other network nodes or network elements or any radio node from where the one or more UEs receive a signal. Examples of radio network nodes are Node B, Base Station (BS), Multi-Standard Radio (MSR) node such as MSR BS, eNode B, network controller, Radio Network Controller (RNC), Base Station Controller (BSC), relay, donor node controlling relay, Base Transceiver Station (BTS), Access Point (AP), transmission points, transmission nodes, RRU, RRH, nodes in Distributed Antenna System (DAS) or other type of radio network node.

Cloud Radio Access Networks (RAN) can enable the implementation of concepts such as software-defined network (SDN) and network function virtualization (NFV) in 5G networks. This disclosure can facilitate a generic channel state information framework design for a 5G network. Certain embodiments of this disclosure can comprise an SDN controller component that can control routing of traffic within the network and between the network and traffic destinations. The SDN controller component can be merged with the 5G network architecture to enable service deliveries via open Application Programming Interfaces (APIs) and move the network core towards an all Internet Protocol (IP), cloud based, and software driven telecommunications network. The SDN controller component can work with, or take the place of Policy and Charging Rules Function (PCRF) network elements so that policies such as quality of service and traffic management and routing can be synchronized and managed end to end.

To meet the huge demand for data centric applications, 4G standards can be applied to 5G, also called New Radio (NR) access. 5G networks can comprise the following: data rates of several tens of megabits per second supported for tens of thousands of users; 1 gigabit per second can be offered simultaneously (or concurrently) to tens of workers on the same office floor; several hundreds of thousands of simultaneous (or concurrent) connections can be supported for massive sensor deployments; spectral efficiency can be enhanced compared to 4G; improved coverage; enhanced signaling efficiency; and reduced latency compared to LTE. In multicarrier system such as OFDM, each subcarrier can occupy bandwidth (e.g., subcarrier spacing). If the carriers use the same bandwidth spacing, then it can be considered a single numerology. However, if the carriers occupy different bandwidth and/or spacing, then it can be considered a multiple numerology.

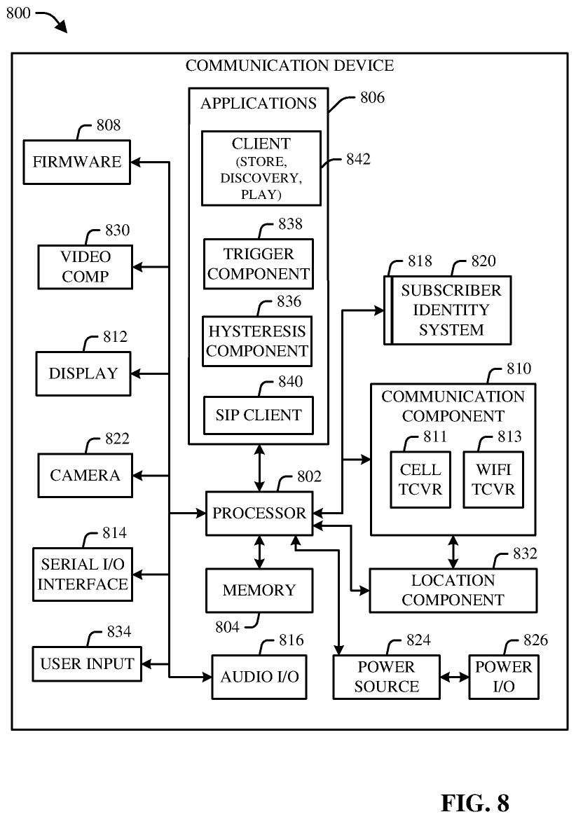

Referring now to FIG. 8, depicted is an example block diagram of an example communication device 800 (e.g., wireless or mobile phone, electronic pad or tablet, electronic eyewear, electronic watch, or other electronic bodywear, IoT device, or other type of communication device) operable to engage in a system architecture that facilitates wireless communications according to one or more embodiments described herein. Although a communication device is illustrated herein, it will be understood that other devices can be a communication device, and that the communication device is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The communication device 800 can include a processor 802 for controlling and processing all onboard operations and functions. A memory 804 interfaces to the processor 802 for storage of data and one or more applications 806 (e.g., a video player software, user feedback component software, or other type of application). Other applications can include voice recognition of predetermined voice commands that facilitate initiation of the user feedback signals. The applications 806 can be stored in the memory 804 and/or in a firmware 808, and executed by the processor 802 from either or both the memory 804 or/and the firmware 808. The firmware 808 can also store startup code for execution in initializing the communication device 800. A communication component 810 interfaces to the processor 802 to facilitate wired/wireless communication with external systems, e.g., cellular networks, VoIP networks, and so on. Here, the communication component 810 can also include a suitable cellular transceiver 811 (e.g., a GSM transceiver) and/or an unlicensed transceiver 813 (e.g., Wi-Fi, WiMax) for corresponding signal communications. The communication device 800 can be a device such as a cellular telephone, a PDA with mobile communications capabilities, and messaging-centric devices. The communication component 810 also facilitates communications reception from terrestrial radio networks (e.g., broadcast), digital satellite radio networks, and Internet-based radio services networks.

The communication device 800 includes a display 812 for displaying text, images, video, telephony functions (e.g., a Caller ID function), setup functions, and for user input. For example, the display 812 can also be referred to as a “screen” that can accommodate the presentation of multimedia content (e.g., music metadata, messages, wallpaper, graphics, or other content). The display 812 can also display videos and can facilitate the generation, editing and sharing of video quotes. A serial I/O interface 814 is provided in communication with the processor 802 to facilitate wired and/or wireless serial communications (e.g., USB, and/or IEEE 1394) through a hardwire connection, and other serial input devices (e.g., a keyboard, keypad, and mouse). This supports updating and troubleshooting the communication device 800, for example. Audio capabilities are provided with an audio I/O component 816, which can include a speaker for the output of audio signals related to, for example, indication that the user pressed the proper key or key combination to initiate the user feedback signal. The audio I/O component 816 also facilitates the input of audio signals through a microphone to record data and/or telephony voice data, and for inputting voice signals for telephone conversations.

The communication device 800 can include a slot interface 818 for accommodating a SIC (Subscriber Identity Component) in the form factor of a card Subscriber Identity Module (SIM) or universal SIM 820, and interfacing the SIM card 820 with the processor 802. However, it is to be appreciated that the SIM card 820 can be manufactured into the communication device 800, and updated by downloading data and software.

The communication device 800 can process IP data traffic through the communication component 810 to accommodate IP traffic from an IP network such as, for example, the Internet, a corporate intranet, a home network, a person area network, or other network, through an ISP or broadband cable provider. Thus, VoIP traffic can be utilized by the communication device 800 and IP-based multimedia content can be received in either an encoded or a decoded format.

A video processing component 822 (e.g., a camera) can be provided for decoding encoded multimedia content. The video processing component 822 can aid in facilitating the generation, editing, and sharing of video quotes. The communication device 800 also includes a power source 824 in the form of batteries and/or an AC power subsystem, which power source 824 can interface to an external power system or charging equipment (not shown) by a power I/O component 826.

The communication device 800 can also include a video component 830 for processing video content received and, for recording and transmitting video content. For example, the video component 830 can facilitate the generation, editing and sharing of video quotes. A location tracking component 832 facilitates geographically locating the communication device 800. As described hereinabove, this can occur when the user initiates the feedback signal automatically or manually. A user input component 834 facilitates the user initiating the quality feedback signal. The user input component 834 can also facilitate the generation, editing and sharing of video quotes. The user input component 834 can include such conventional input device technologies such as a keypad, keyboard, mouse, stylus pen, and/or touch screen, for example.

Referring again to the applications 806, a hysteresis component 836 facilitates the analysis and processing of hysteresis data, which is utilized to determine when to associate with the access point. A software trigger component 838 can be provided that facilitates triggering of the hysteresis component 836 when the Wi-Fi transceiver 813 detects the beacon of the access point. A SIP client 840 enables the communication device 800 to support SIP protocols and register the subscriber with the SIP registrar server. The applications 806 can also include a client 842 that provides at least the capability of discovery, play and store of multimedia content, for example, music.

The communication device 800, as indicated above related to the communication component 810, includes an indoor network radio transceiver 813 (e.g., Wi-Fi transceiver). This function supports the indoor radio link, such as IEEE 802.11, for the dual-mode GSM device (e.g., communication device 800). The communication device 800 can accommodate at least satellite radio services through a device (e.g., handset device) that can combine wireless voice and digital radio chipsets into a single device (e.g., single handheld device).

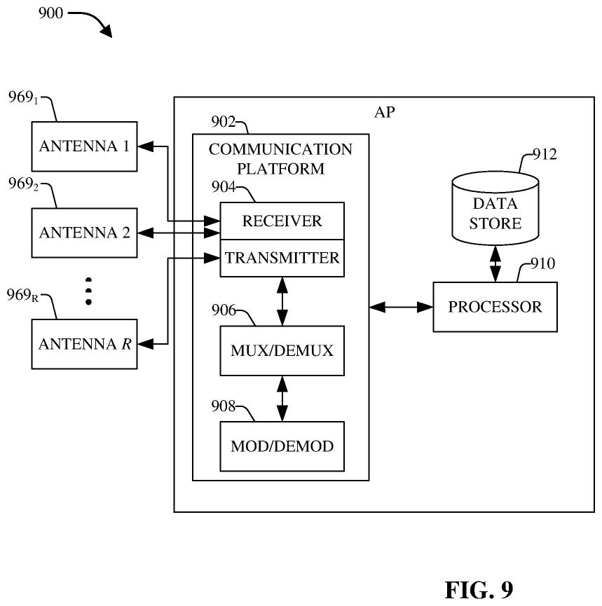

FIG. 9 illustrates a block diagram of an example access point (AP) 900 (e.g., macro base station, femto AP, pico AP, Wi-Fi AP, Wi-Fi-direct AP, or other type of AP), in accordance with various aspects and embodiments of the disclosed subject matter. The AP 900 can receive and transmit signal(s) from and to wireless devices like access points (e.g., base stations, femtocells, picocells, or other type of AP), access terminals (e.g., UEs), wireless ports and routers, and the like, through a set of antennas 9691-969R. In an aspect, the antennas 9691-969R are a part of a communication platform 902, which comprises electronic components and associated circuitry that can provide for processing and manipulation of received signal(s) and signal(s) to be transmitted. In an aspect, the communication platform 902 can include a receiver/transmitter 904 that can convert signal from analog to digital upon reception, and from digital to analog upon transmission. In addition, receiver/transmitter 904 can divide a single data stream into multiple, parallel data streams, or perform the reciprocal operation.

In an aspect, coupled to receiver/transmitter 904 can be a multiplexer/demultiplexer (mux/demux) 906 that can facilitate manipulation of signal in time and frequency space. The mux/demux 906 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), or another desired multiplexing scheme. In addition, mux/demux component 906 can scramble and spread information (e.g., codes) according to substantially any code known in the art, e.g., Hadamard-Walsh codes, Baker codes, Kasami codes, polyphase codes, and so on. A modulator/demodulator (mod/demod) 908 also can be part of the communication platform 902, and can modulate information according to multiple modulation techniques, such as frequency modulation, amplitude modulation (e.g., M-ary quadrature amplitude modulation (QAM), with M a positive integer), phase-shift keying (PSK), and the like.

The AP 900 also can comprise a processor(s) 910 that can be configured to confer and/or facilitate providing functionality, at least partially, to substantially any electronic component in or associated with the AP 900. For instance, the processor(s) 910 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, or other operations on data.

In another aspect, the AP 900 can include a data store 912 that can store data structures; code instructions; rate coding information; information relating to measurement of radio link quality or reception of information related thereto; information relating to communication conditions (e.g., signal-to-interference-plus-noise ratio (SINR), reference signal received power (RSRP), reference signal received quality (RSRQ), channel quality indicator (CQI), and/or other wireless communications metrics or parameters) associated with communication devices; information relating to communication devices, users, subscriber-related information, usage data, historical usage data, location data (e.g., data regarding locations of communication devices), queries, power information, applications, services, threshold values (e.g., defined threshold data throughput values, defined threshold QoS values, or other type of threshold value), metadata, parameters, traffic flows, policies, rules, signaling, defined network security criteria, network security algorithms, protocols, interfaces, tools, and/or other information; white list information, information relating to managing or maintaining the white list; system or device information like policies and specifications; code sequences for scrambling; spreading and pilot transmission; floor plan configuration; access point deployment and frequency plans; scheduling policies; and so on. The processor(s) 910 can be coupled to the data store 912 in order to store and retrieve information (e.g., information, such as algorithms, relating to multiplexing/demultiplexing or modulation/demodulation; information relating to radio link levels; information relating to communication conditions (e.g., SINR, RSRP, RSRQ, CQI, and/or other wireless communications metrics or parameters) associated with communication devices; information relating to communication devices, users, subscriber-related information, usage data, historical usage data, location data (e.g., data regarding locations of communication devices), queries, power information, applications, services, threshold values (e.g., defined threshold data throughput values, defined QoS values, or other type of threshold value), metadata, parameters, traffic flows, policies, rules, signaling, defined network security criteria, network security algorithms, protocols, interfaces, tools, and/or other information that can be desired to operate and/or confer functionality to the communication platform 902 and/or other operational components of AP 900.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

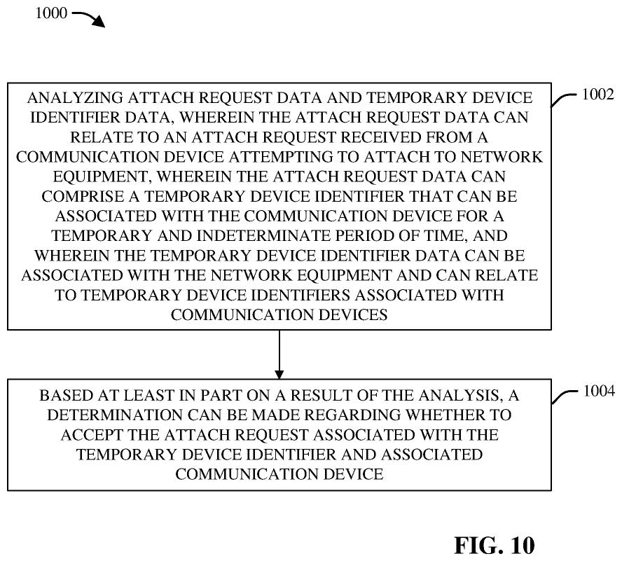

In view of the example systems and/or devices described herein, example methods that can be implemented in accordance with the disclosed subject matter can be further appreciated with reference to flowcharts in FIGS. 10-13. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 10 illustrates a flow chart of an example method 1000 that can determine whether to accept an attach request associated with a temporary device identifier associated with a communication device in connection with determining whether the communication device is an aggressive communication device, to facilitate mitigating aggressive and/or malicious events against a RAN and/or associated communication network, in accordance with various aspects and embodiments of the disclosed subject matter. The method 1000 can be employed by, for example, a system comprising the SMC, a processor component (e.g., of or associated with the SMC), and/or a data store (e.g., of or associated with the SMC).

At 1002, attach request data and temporary device identifier data can be analyzed, wherein the attach request data can relate to an attach request received from a communication device attempting to attach to network equipment, wherein the attach request data can comprise a temporary device identifier that can be associated with the communication device for a temporary and indeterminate period of time, and wherein the temporary device identifier data can be associated with the network equipment and can relate to temporary device identifiers associated with communication devices. For instance, the SMC can analyze the attach request data relating to the attach request and the temporary device identifier data associated with the network equipment (e.g., the RAN).

At 1004, based at least in part on a result of the analysis, a determination can be made regarding whether to accept the attach request associated with the temporary device identifier and associated communication device. The SMC can determine whether to accept the attach request associated with the temporary device identifier and associated communication device based at least in part on the result of the analysis of the attach request data, including the temporary device identifier, and the temporary device identifier data (e.g., the list of temporary device identifiers associated with benign communication devices and/or the list of temporary device identifiers associated with aggressive communication devices), in accordance with the defined network security criteria, such as more fully described herein.

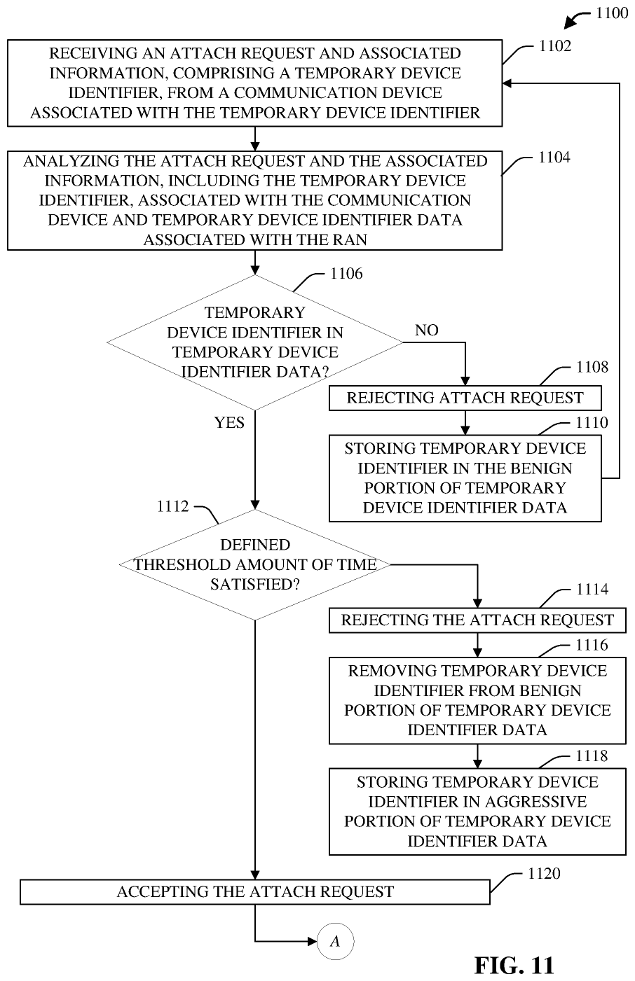

FIG. 11 depicts a flow chart of an example method 1100 that can detect, determine, and/or distinguish between aggressive communication devices and benign communication devices to facilitate mitigating aggressive and/or malicious events by aggressive communication devices against a RAN and/or associated communication network, in accordance with various aspects and embodiments of the disclosed subject matter. The method 1100 can be employed by, for example, a system comprising the SMC, a processor component (e.g., of or associated with the SMC), and/or a data store (e.g., of or associated with the SMC).

At 1102, an attach request and associated information, comprising a temporary device identifier, can be received from a communication device associated with the temporary device identifier. The SMC of or associated with the RAN can receive the attach request (e.g., attach or registration request) and the associated information (e.g., temporary device identifier, device identifier (e.g., encrypted device identifier), time information relating to the attach request, and/or metadata), from the communication device associated with the temporary device identifier via a base station. For instance, the base station can receive the attach request and the associated information from the communication device when the communication device attempts and desires to attach or register to or with the RAN and associated communication network. The temporary device identifier can be associated with the attach request and the communication device, as more fully described herein. The base station can communicate the attach request and the associated information, including the temporary device identifier, to the SMC.

At 1104, the attach request and the associated information, including the temporary device identifier, associated with the communication device and temporary device identifier data associated with the RAN can be analyzed. At 1106, a determination can be made regarding whether the temporary device identifier is contained in the temporary device identifier data based at least in part on the analysis results. The SMC can analyze the temporary device identifier and the temporary device identifier data (e.g., the portion (e.g., benign temporary device identifier portion) of the temporary device identifier data that comprises a list of temporary device identifiers associated with benign communication devices). Based at least in part on the results of analyzing the temporary device identifier and the temporary device identifier data, the SMC can determine whether the temporary device identifier associated with the communication device is contained in the temporary device identifier data (e.g., the SMC can determine whether the temporary device identifier associated with the communication device is included in the list of temporary device identifiers associated with benign communication devices). In some embodiments, based at least in part on the analysis, the SMC also can determine whether the temporary device identifier data is contained in the aggressive temporary device identifier portion of the temporary device identifier data that comprises the list of temporary device identifiers associated with aggressive communication devices.

If it is determined that the temporary device identifier is not contained in the temporary device identifier data, at 1108, the attach request can be rejected. At 1110, the temporary device identifier can be stored in a benign portion of the temporary device identifier data. For instance, if the SMC determines that the temporary device identifier is not contained in the temporary device identifier data, the SMC can determine that the attach request of the communication device is a first attach request associated with the temporary device identifier, and, accordingly, the attach request can be rejected, in accordance with the defined network security criteria. The SMC can communicate a rejection message regarding the rejection of the attach request to the base station, and the base station can forward (e.g., communicate) the rejection message to the communication device. The SMC also can update the temporary device identifier data (e.g., the benign temporary device identifier portion of the temporary device identifier data) to include the temporary device identifier associated with the communication device. In some embodiments, at this point, the method 1100 can return to reference numeral 1102, for instance, where a second (or third or other subsequent) attach request can be received from the communication device, if such second (or third or other subsequent) attach request is sent by the communication device to the RAN.

Referring again to reference numeral 1106, if, at 1106, it is determined that the temporary device identifier is contained in the temporary device identifier data, at 1112, a determination can be made regarding whether a defined threshold amount of time relating to attach requests has been satisfied with regard to the attach request. For instance, if the SMC determines that the temporary device identifier is contained in the temporary device identifier data (e.g., the benign temporary device identifier portion of the temporary device identifier data), the SMC can determine that the communication device associated with the temporary device identifier has previously sent an attach request to the RAN. The SMC can determine whether an amount of time between the previous attach request and the current attach request satisfies (e.g., meets or exceeds; is greater than or equal to) the defined threshold amount of time (e.g., the minimum threshold amount of time) relating to attach requests, wherein the defined threshold amount of time can indicate how much time (e.g., the minimum threshold amount of time) a communication device is supposed to wait after sending a first (or previous) attach request to the RAN before sending a second (or current) attach request to the RAN. If the communication device associated with the temporary device identifier is sending the second attach request to the RAN without waiting the defined threshold amount of time after sending the first attach request to the RAN, this can indicate that the communication device potentially can be acting in an undesirably aggressive or malicious manner In accordance with various embodiments, a backoff timer of or associated with the SMC can indicate the amount of time that has elapsed between attach requests received from a communication device and/or there can be respective time information (e.g., respective time stamps) associated with respective attach requests received from a communication device. The SMC can, for example, analyze first time information associated with the previous attach request associated with the temporary device identifier associated with the communication device and second time information associated with the current attach request associated with the temporary device identifier, and/or can analyze the amount of time that has elapsed on a backoff timer associated with the previous and current attach requests associated with the temporary device identifier. Based at least in part on the results of such analysis, the SMC can determine whether the defined threshold amount of time relating to attach requests has been satisfied with regard to the attach request associated with the temporary device identifier associated with the communication device.

In some embodiments, if the communication device attempted to attach again and was assigned a different temporary device identifier in connection with that attach request, the SMC can reject such attach request associated with the different temporary device identifier (e.g., reject the initial attach request with regard to the different temporary device identifier), such as described herein at reference numeral 1108, since the SMC can determine that the different temporary device identifier is not in the temporary device identifier data.

At 1114, if it is determined that the defined threshold amount of time relating to attach requests has not been satisfied with regard to the attach request, the attach request can be rejected. For instance, if the SMC determines that the defined threshold amount of time relating to attach requests has not been satisfied with regard to the attach request associated with the temporary device identifier associated with the communication device, the SMC can determine that the attach request can be rejected, and can reject the attach request, as such failure of the defined threshold amount of time between the previous (e.g., first) attach request and current (e.g., second) attach request associated with the temporary device identifier can indicate that the communication device can be, or at least potentially can be, acting in an undesirably aggressive and/or malicious manner.

At 1116, the temporary device identifier can be removed from the benign portion of the temporary device identifier data. At 1118, the temporary device identifier can be stored in an aggressive portion of the temporary device identifier data. In response to determining that the defined threshold amount of time relating to attach requests has not been satisfied and the attach request has been rejected, the SMC can remove the temporary device identifier from the benign portion of the temporary device identifier data, and can store the temporary device identifier in the aggressive portion of the temporary device identifier data (e.g., the list of temporary device identifiers associated with aggressive communication devices).

Referring again to reference numeral 1112, if, at 1112, it is determined that the defined threshold amount of time relating to attach requests has been satisfied with regard to the attach request, at 1120, the attach request can be accepted. If the SMC determines the defined threshold amount of time relating to attach requests has been satisfied with regard to the attach request associated with the temporary device identifier, the SMC can determine that the attach request can be accepted (e.g., allowed or permitted), and the SMC can allow the attach request to be further processed (e.g., by the SMC, RAN, and/or core network) to enable the communication device to be attached to the RAN, base station, and/or core network. For instance, the SMC determining that the communication device has submitted two attach requests, with the first (previous) attach request being rejected, and has waited the defined threshold amount of time after sending the previous (first) attach request before submitting the current (second) attach request can indicate to the SMC that the communication device is acting in a benign manner, or at least does not appear to be acting in an undesirably aggressive and/or malicious manner at this time, and accordingly, the SMC can accept the attach request.

In some embodiments, at this point, the method 1100 can proceed to reference point A, wherein method 1200 can proceed from reference point A, such as described herein.

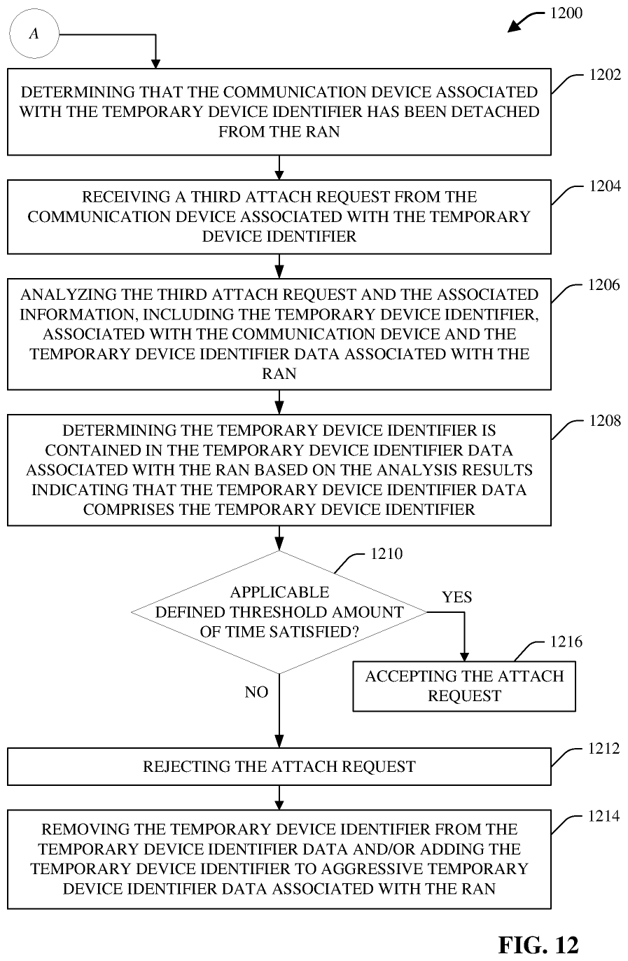

FIG. 12 illustrates a flow chart of an example method 1200 that can detect, determine, and/or distinguish between aggressive communication devices and benign communication devices, including aggressive communication devices that undesirably (e.g., aggressively) attempt to attach, detach, and reattach to a communication network to facilitate mitigating aggressive and/or malicious events by aggressive communication devices against a RAN and/or associated communication network, in accordance with various aspects and embodiments of the disclosed subject matter. The method 1200 can be employed by, for example, a system comprising the SMC, a processor component (e.g., of or associated with the SMC), and/or a data store (e.g., of or associated with the SMC). In some embodiments, the method 1200 can proceed from reference point A of the method 1100, as shown in FIG. 11.

At 1202, a determination can be made that the communication device associated with the temporary device identifier has been detached from the RAN. For instance, after the SMC accepted the second attach request associated with the temporary device identifier and associated communication device to allow the communication device to attach to the RAN, base station, and/or core network, the SMC can receive information indicating that the communication device associated with the temporary device identifier can be detached from the RAN, base station, and/or core network (e.g., the communication device can have its communication connection detached or released from the RAN, base station, and/or core network). For example, the RAN can receive a detach request (e.g., detach request message) from the communication device associated with the temporary device identifier (e.g., via the base station or another base station of the RAN) indicating that the communication device desires to detach from the RAN, base station, and/or core network. In response, the RAN, base station, and/or core network can detach or disconnect the communication device from the RAN, base station, and/or core network, and, subsequent to the detach event, the SMC can determine that the communication device associated with the temporary device identifier has been detached from the communication network.

At 1204, a third attach request can be received from the communication device associated with the temporary device identifier. The SMC of or associated with the RAN can receive the third attach request (e.g., registration request) from the communication device associated with the temporary device identifier via the base station.

At 1206, the third attach request and the associated information, including the temporary device identifier, associated with the communication device and the temporary device identifier data associated with the RAN can be analyzed. At 1208, a determination can be made that the temporary device identifier is contained in the temporary device identifier data associated with the RAN based at least in part on the analysis results indicating that the temporary device identifier data comprises the temporary device identifier. The SMC can analyze the attach request and the associated information associated with the third attach request, including the temporary device identifier, time information relating to sending of the third attach request, and/or metadata, and the temporary device identifier data (e.g., the benign temporary device identifier portion that comprises the list of temporary device identifiers associated with benign communication devices). Based at least in part on the results of analyzing the third attach request, the associated information, and the temporary device identifier data, the SMC can determine whether the temporary device identifier associated with the third attach request and communication device is contained in the temporary device identifier data (e.g., the SMC can determine whether the temporary device identifier associated with the communication device is included in the list of temporary device identifiers associated with benign communication devices). Since the temporary device identifier was provided with a previous attach request that was accepted by the SMC, the SMC can maintain the temporary device identifier associated with the communication device in the temporary device identifier data for a desired amount of time, even after detachment of the communication device from the RAN, base station, and/or core network. In some embodiments, the desired amount of time the temporary device identifier associated with the communication device can be maintained in the temporary device identifier data can be a length of time that can meet or exceed the defined threshold amount of time (e.g., the amount of time associated with the backoff timer) and/or another threshold amount of time that can be greater than (e.g., longer than) the defined threshold amount of time. In this example instance, the temporary device identifier data can comprise the temporary device identifier, and accordingly, from the analysis, the SMC can determine that the temporary device identifier is contained in the temporary device identifier data associated with the RAN.

In response to determining that the temporary device identifier is contained in the temporary device identifier data, at 1210, a determination can be made regarding whether an applicable defined threshold amount of time relating to attach requests has been satisfied with regard to the attach request. For instance, based at least in part on results of an analysis of time information associated with the current and previous attach requests associated with the temporary device identifier, the SMC can determine whether the applicable defined threshold amount of time relating to attach requests has been satisfied with regard to the current (e.g., third) attach request associated with the temporary device identifier associated with the communication device in relation to the previous (e.g., second) attach request associated with the temporary device identifier, as more fully described herein. In some embodiments, the applicable defined threshold amount of time can be a longer amount of time than the defined threshold amount of time, and thus, even if the third attach request can satisfy the defined threshold amount of time, if the third attach request does not satisfy the applicable (e.g., longer) defined threshold amount of time, this can indicate that the communication device is or may be exhibiting undesirably aggressive behavior.

If it is determined that the applicable defined threshold amount of time relating to attach requests has not been satisfied with regard to the attach request (e.g., the third attach request), at 1212, the attach request can be rejected. At 1214, the temporary device identifier associated with the communication device can be removed from the temporary device identifier data and/or can be added to aggressive temporary device identifier data associated with the RAN and/or base station. If the SMC determines that the applicable defined threshold amount of time relating to attach requests has not been satisfied with regard to the attach request associated with the temporary device identifier associated with the communication device, the SMC can determine that the attach request can be rejected, and can reject the attach request, as such failure of the applicable defined threshold amount of time between the previous (e.g., second) attach request and current (e.g., third) attach request associated with the temporary device identifier can indicate that the communication device can be, or at least potentially can be, acting in an undesirably aggressive and/or malicious manner. The SMC also can remove the temporary device identifier associated with the communication device from the temporary device identifier data associated with the RAN and/or base station and/or can add the temporary device identifier data to the aggressive temporary device identifier data (e.g., the aggressive temporary device identifier portion of the temporary device identifier data) associated with the RAN and/or base station, wherein the aggressive temporary device identifier data (e.g., list of temporary device identifiers associated with blocked, aggressive, and/or malicious communication devices) can comprise one or more temporary device identifiers (e.g., the temporary device identifier associated with the communication device) that can be associated with one or more blocked, aggressive, and/or malicious communication devices.

Referring again to reference numeral 1210, if it is determined that the applicable defined threshold amount of time relating to attach requests has been satisfied with regard to the attach request (e.g., the third attach request), at 1216, the attach request can be accepted. If the SMC determines the applicable defined threshold amount of time relating to attach requests has been satisfied with regard to the attach request associated with the temporary device identifier, the SMC can determine that the attach request can be accepted, and the SMC can allow the attach request to be further processed (e.g., by the SMC, RAN, and/or core network) to enable the communication device to be attached (e.g., attached again) to the RAN, base station, and/or core network. For instance, the SMC determining that the communication device has submitted multiple attach requests, and had been attached to and subsequently detached from the communication network before sending the current (e.g., third) attach request, but has waited the applicable defined threshold amount of time after the previous (e.g., second) attach request before submitting the current (e.g., third) attach request, can indicate to the SMC that the communication device is acting in a benign manner, or at least does not appear to be acting in an undesirably aggressive and/or malicious manner at this time, and accordingly, the SMC can accept the attach request. The SMC also can continue to maintain the temporary device identifier as part of the benign portion of the temporary device identifier data for at least the desired amount of time after the current attach request.

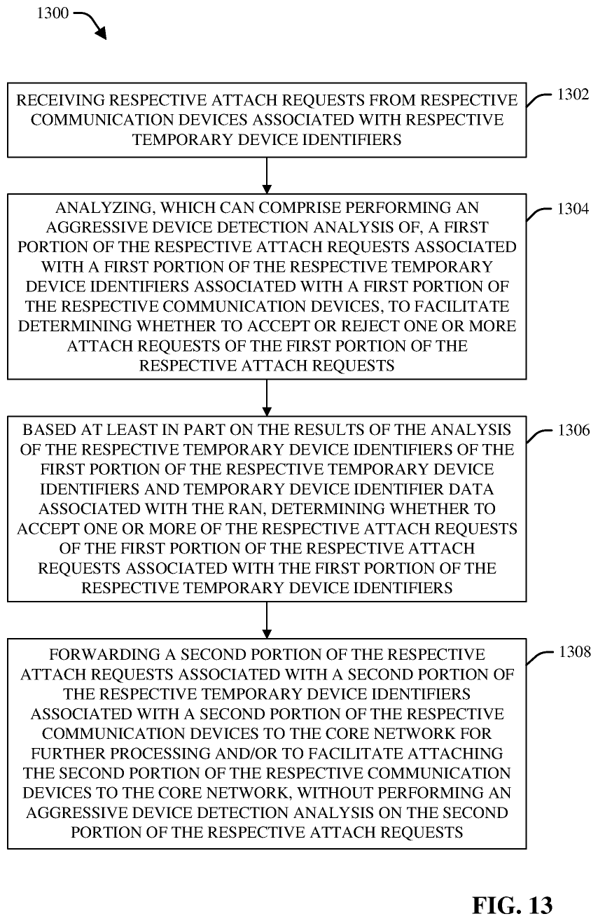

FIG. 13 presents a flow chart of another portion of the example method 1300 that can apportion or allocate attach requests associated with communication devices to facilitate performing an aggressive device detection analysis on a first portion of the attach requests by the SMC while forwarding a second portion of the attach requests to the packet core component of the core network without performing an aggressive device detection analysis on the second portion of the attach requests, in accordance with various aspects and embodiments of the disclosed subject matter. The method 1300 can be employed by, for example, a system comprising the SMC, a processor component (e.g., of or associated with the SMC), and/or a data store (e.g., of or associated with the SMC).

At 1302, respective attach requests can be received from respective communication devices associated with respective temporary device identifiers. The SMC of or associated with the RAN can receive the respective attach requests (e.g., registration requests) from the respective communication devices associated with the temporary device identifiers via one or more base stations associated with the RAN, for example, over a defined time period. For instance, the one or more base stations can receive the respective attach requests from the respective communication devices when the respective communication devices attempt and desire to attach or register to or with the RAN. The one or more base stations can communicate the respective attach requests and associated respective temporary device identifiers to the SMC for further processing.

At 1304, a first portion of the respective attach requests associated with a first portion of the respective temporary device identifiers associated with a first portion of the respective communication devices can be analyzed, which can include performing an aggressive device detection analysis, to facilitate determining whether to accept or reject one or more attach requests of the first portion of the respective attach requests associated with the first portion of the temporary device identifiers. The SMC can analyze (e.g., perform the aggressive device detection analysis on) the first portion of the respective attach requests associated with the first portion of the respective temporary device identifiers associated with the first portion of the respective communication devices.

At 1306, based at least in part on the results of the analysis of the respective temporary device identifiers of the first portion of the respective temporary device identifiers and temporary device identifier data associated with the RAN, a determination can be made regarding whether to accept one or more of the respective attach requests of the first portion of the respective attach requests associated with the first portion of the respective temporary device identifiers, in accordance with the defined network security criteria. For instance, based at least in part on the results of the analysis of the respective temporary device identifiers of the first portion of the respective temporary device identifiers, the SMC can determine whether to accept one or more of the respective attach requests of the first portion of the respective attach requests associated with the first portion of the respective temporary device identifiers, in accordance with the defined network security criteria, such as more fully described herein.

At 1308, a second portion of the respective attach requests associated with a second portion of the respective temporary device identifiers associated with a second portion of the respective communication devices can be forwarded to the core network for further processing and/or to facilitate attaching the second portion of the respective communication devices to the core network, without performing an aggressive device detection analysis on the second portion of the respective attach requests. In some embodiments, the SMC can forward (e.g., communicate or send) the second portion of the respective attach requests associated with the second portion of the respective temporary device identifiers associated with the second portion of the respective communication devices to the packet core component of the core network for further processing and/or to facilitate attaching the second portion of the respective communication devices to the core network, without performing an aggressive device detection analysis on the second portion of the respective attach requests.

In some embodiments, the packet core component can process the second portion of the respective attach requests and can attach, connect, and/or register the second portion of the respective communication devices to the core network. In certain embodiments, the packet core component can analyze the second portion of the respective attach requests and, based at least in part on such analysis results, the packet core component can determine respective device identifiers (e.g., IMSI or IMEI) associated with the respective communication devices of the second portion of the respective communication devices. Based at least in part on further analysis of the respective device identifiers and device identifier data associated with (e.g., maintained by or stored in the core network), the packet core component can determine whether to accept or reject one or more attach requests of the second portion of the respective attach requests associated with the second portion of the device identifiers, in accordance with the defined network security criteria, such as more fully described herein. For instance, based at least in part on the results of the analysis of the respective device identifiers associated with the respective communication devices of the second portion of the respective communication devices and the device identifier data associated with the core network, the packet core component can or may determine that a device identifier associated with a communication device is included in a list of aggressive devices, or alternatively, can or may determine that a device identifier associated with a communication device is included in a list of benign devices. The packet core component can allow a benign communication device to attach to and register with the core network, and can reject an attach request of a communication device determined to be aggressive, in accordance with the defined network security criteria.

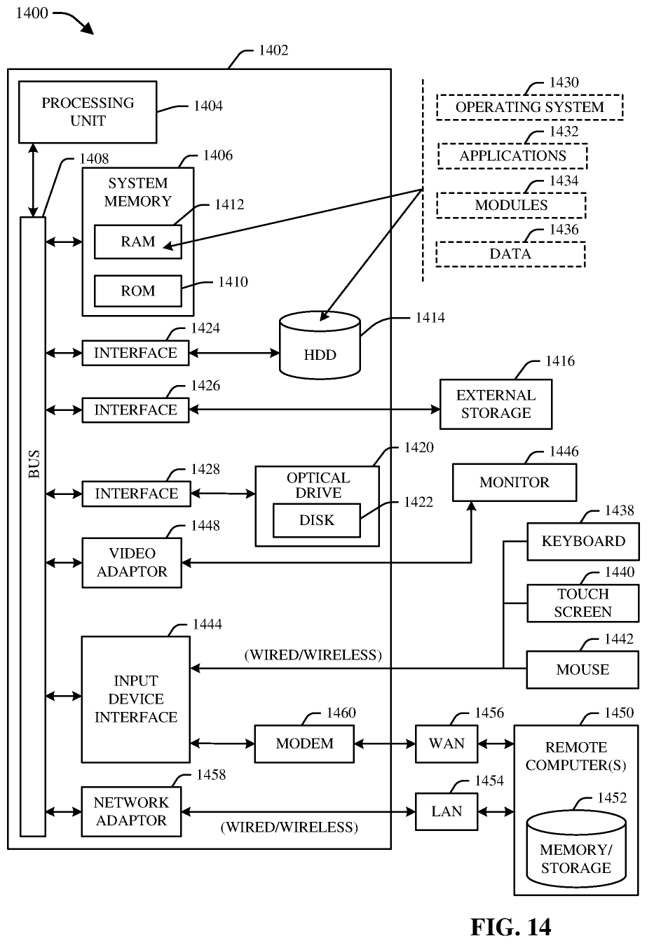

In order to provide additional context for various embodiments described herein, FIG. 14 and the following discussion are intended to provide a brief, general description of a suitable computing environment 1400 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments of the aspects described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a non-volatile memory such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, or other type of storage device) and an optical disk drive 1420 (e.g., which can read or write from a CD-ROM disc, a DVD, a BD, or other disk drive). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enable with a security module, such as a trusted processing module (TPM). For instance with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH™ interface, or other type of interface.

A monitor 1446 or other type of display device can be also connected to the system bus 1408 via an interface, such as a video adapter 1448. In addition to the monitor 1446, a computer typically includes other peripheral output devices (not shown), such as speakers, printers, or other type of peripheral output device.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are example and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456, e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, or other equipment or entity), and telephone. This can include Wireless Fidelity (Wi-Fi) and BLUETOOTH™ wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, or other alphanumeric character) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

It is to be noted that aspects, features, and/or advantages of the disclosed subject matter can be exploited in substantially any wireless telecommunication or radio technology, e.g., Wi-Fi; Gi-Fi; Hi-Fi; BLUETOOTH™; worldwide interoperability for microwave access (WiMAX); enhanced general packet radio service (enhanced GPRS); third generation partnership project (3GPP) long term evolution (LTE); third generation partnership project 2 (3GPP2) ultra mobile broadband (UMB); 3GPP universal mobile telecommunication system (UMTS); high speed packet access (HSPA); high speed downlink packet access (HSDPA); high speed uplink packet access (HSUPA); GSM (global system for mobile communications) EDGE (enhanced data rates for GSM evolution) radio access network (GERAN); UMTS terrestrial radio access network (UTRAN); LTE advanced (LTE-A); or other type of wireless telecommunication or radio technology. Additionally, some or all of the aspects described herein can be exploited in legacy telecommunication technologies, e.g., GSM. In addition, mobile as well non-mobile networks (e.g., the internet, data service network such as internet protocol television (IPTV), or other network) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, or other type of magnetic storage device), optical discs (e.g., compact disc (CD), digital versatile disc (DVD), blu-ray disc (BD), or other type of optical disc), smart cards, and memory devices comprising volatile memory and/or non-volatile memory (e.g., flash memory devices, such as, for example, card, stick, key drive, or other type of memory device), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field PGA (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component”, “system”, “platform”, “framework”, “layer”, “interface”, “agent”, and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment” (UE), “mobile station,” “mobile,” “wireless device,” “wireless communication device,” “subscriber station,” “subscriber equipment,” “access terminal,” “terminal,” “handset,” and similar terminology are used herein to refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point” (AP), “base station,” “node B,” “evolved node B” (eNode B or eNB), “home node B” (HNB), “home access point” (HAP), and the like are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” “consumer,” “owner,” “agent,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., communication device, RAN, RIC, base station, communication network, security management component, detector component, attachment manager component, AI component, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
analyzing, by a system comprising a processor, attach request data and temporary device identifier data, wherein the attach request data relates to an attach request received from a device attempting to attach to network equipment, wherein the attach request data comprises a temporary device identifier that is associated with the device for a temporary and indeterminate period of time, and wherein the temporary device identifier data is associated with the network equipment and relates to temporary device identifiers associated with devices; and
based on a result of the analyzing, determining, by the system, whether to accept the attach request associated with the device.

2. The method of claim 1, wherein the temporary device identifier comprises a temporary mobile subscriber identity or a cell radio network temporary identifier, wherein the attach request data further comprises a device identifier associated with the device, wherein the device identifier is encrypted and is not able to be determined by the system, and wherein the device identifier comprises an international mobile equipment identity value or an international mobile subscriber identity value.

3. The method of claim 1, further comprising:
determining, by the system, whether the attach request is a first attach request associated with the temporary device identifier associated with the device based on the result of the analyzing, wherein the result of the analyzing indicates whether the temporary device identifier data comprises the temporary device identifier, and wherein the temporary device identifier data comprises the temporary device identifiers associated with attach requests previously received by the network equipment.

4. The method of claim 3, further comprising:
in response to determining that the temporary device identifier data does not comprise the temporary device identifier, determining, by the system, that the attach request is the first attach request associated with the temporary device identifier;
rejecting, by the system, the attach request;
storing, by the system, the temporary device identifier in the temporary device identifier data associated with the network equipment to generate updated temporary device identifier data; and
communicating, by the system, a rejection message to the device, wherein the rejection message indicates that the attach request has been rejected.

5. The method of claim 4, wherein the attach request data relating to the attach request is first attach data relating to the first attach request, wherein the temporary device identifier is a first temporary device identifier, wherein the rejection message is a first rejection message, and wherein the method further comprises:
receiving, by the system, second attach request data relating to a second attach request associated with a second temporary device identifier and the device;
analyzing, by the system, the updated temporary device identifier data and the second attach request data, the second attach request data comprising the second temporary device identifier;
in response to determining that the updated temporary device identifier data does not comprise the second temporary device identifier, determining, by the system, that the second attach request is a first attach request attempt associated with the second temporary device identifier;
rejecting, by the system, the second attach request;
storing, by the system, the second temporary device identifier in the updated temporary device identifier data associated with the network equipment to generate second updated temporary device identifier data; and
communicating, by the system, a second rejection message to the device, wherein the second rejection message indicates that the second attach request has been rejected.

6. The method of claim 3, wherein the result is a first result, and wherein the method further comprises:
in response to determining that the temporary device identifier data comprises the temporary device identifier, determining, by the system, that the attach request is not the first attach request associated with the temporary device identifier that has been received by the network equipment, wherein a previous attach request associated with the temporary device identifier had been received by the network equipment prior to the attach request, wherein the temporary device identifier data comprises first time data that indicates a first time that the previous attach request was sent by the device, and wherein the attach request data comprises second time data that indicates a second time that the attach request was sent by the device; and
based on a second result of the analyzing, determining, by the system, whether an amount of time between the second time of a second sending of the attach request and the first time of a first sending of the previous attach request by the device satisfies a defined amount of time relating to sending of attach requests.

7. The method of claim 6, further comprising:
in response to determining that the amount of time does not satisfy the defined amount of time, determining, by the system, that the device is acting in a defined aggressive manner and the attach request is to be rejected;
to facilitate rejection of future attach requests associated with the temporary device identifier, storing, by the system, device-related data, comprising the temporary device identifier, associated with the device in a group of aggressive device-related data associated with devices determined to have acted in the defined aggressive manner; and
communicating, by the system, a rejection message to the device, wherein the rejection message indicates that the attach request has been rejected.

8. The method of claim 6, further comprising:
in response to determining that the amount of time satisfies the defined amount of time, determining, by the system, that the attach request is to be accepted; and
communicating, by the system, an accept message to the device, wherein the accept message indicates that the attach request has been accepted.

9. The method of claim 1, further comprising:
in response to accepting the attach request, communicating, by the system, the attach request data relating to the attach request from radio access network equipment associated with a radio access network to packet core network equipment associated with a core network for further processing, wherein the network equipment comprises or is associated with the radio access network equipment or the packet core network equipment.

10. The method of claim 1, wherein the result is a first result, wherein the temporary device identifier data is updated to generate updated temporary device identifier data comprising the temporary device identifier and first time data indicating a first time that the attach request was sent by the device, wherein the attach request is accepted based on the first result of the analyzing, and wherein the method further comprises:
subsequent to accepting the attach request and connecting the device to the network equipment, receiving, by the system, disconnect information indicating that the device has disconnected from the network equipment;
receiving, by the system, subsequent attach request data relating to a subsequent attach request received from the device attempting to attach to the network equipment, wherein the subsequent attach request data comprises the temporary device identifier and second time data indicating a second time that the subsequent attach request was sent by the device;
analyzing, by the system, the subsequent attach request data and the updated temporary device identifier data; and
based on a second result of the analyzing of the subsequent attach request data and the updated temporary device identifier data, determining, by the system, whether an amount of time between the second time of a second sending of the subsequent attach request and the first time of a first sending of the attach request by the device satisfies a defined amount of time relating to sending of attach requests, to facilitate determining whether to accept the subsequent attach request associated with the device.

11. The method of claim 10, further comprising:
in response to determining that the amount of time does not satisfy the defined amount of time, determining, by the system, that the device is acting in a defined aggressive manner and the subsequent attach request is to be rejected;
deleting, by the system, the temporary device identifier from the updated temporary device identifier data associated with the network equipment to generate second updated temporary device identifier data;
to facilitate rejection of future attach requests associated with the temporary device identifier, storing, by the system, device-related data, comprising the temporary device identifier, associated with the device in a group of aggressive device-related data associated with devices determined to have acted in the defined aggressive manner; and
communicating, by the system, a rejection message to the device, wherein the rejection message indicates that the subsequent attach request has been rejected.

12. The method of claim 10, further comprising:
in response to determining that the amount of time satisfies the defined amount of time, determining, by the system, that the subsequent attach request is to be accepted and the device is acting in a non-aggressive manner at least with regard to the subsequent attach request; and
communicating, by the system, an accept message to the device, wherein the accept message indicates that the subsequent attach request has been accepted.

13. The method of claim 1, further comprising:
over a given period of time, receiving, by the system, respective attach request data associated with respective attach requests from respective devices, wherein the respective attach request data comprises respective temporary device identifiers associated with the respective devices, wherein the respective temporary device identifiers comprise the temporary device identifier, wherein the respective attach requests comprise first attach requests associated with a first group of the respective devices and second attach requests associated with a second group of the respective devices, and wherein the first group of the respective devices comprises the device;
analyzing, by the system, a first portion of the respective attach request data associated with the first attach requests to facilitate determining whether to accept one or more of the first accept requests, in accordance with defined network security criteria relating to sending of attach requests; and
forwarding, by the system, a second portion of the respective attach request data associated with the second attach requests from the network equipment associated with a radio access network to a packet core network device associated with a core network for processing of the second attach requests.

14. A system, comprising:
a processor; and
a memory that stores executable instructions that, when executed by the processor, facilitate performance of operations, comprising:
evaluating attach request information and temporary user equipment identifier information, wherein the attach request information is associated with an attach request received from user equipment attempting to attach to network equipment, wherein the attach request information comprises a temporary user equipment identifier that is associated with the user equipment for an unspecified time period, and wherein the temporary user equipment identifier information is associated with the network equipment and relates to temporary user equipment identifiers associated with user equipments; and
based on a result of the evaluating, determining whether to accept the attach request associated with the user equipment.

15. The system of claim 14, wherein the operations further comprise:
determining whether suspected aggressive behavior report data has been received, or whether an amount of signaling associated with the network equipment satisfies a defined threshold amount of signaling that indicates whether aggressive or potentially aggressive behavior is being exhibited by one or more user equipments associated with the network equipment, wherein the suspected aggressive behavior report data indicates detection of the aggressive or potentially aggressive behavior by the one or more user equipments, and wherein the signaling comprises the attach request; and
one of:
in response to determining that no suspected aggressive behavior report data has been received, and in response to determining that the defined threshold amount of signaling is not satisfied, determining that an aggressive user equipment detection analysis is not to be performed; or
in response to at least one of determining that the suspected aggressive behavior report data has been received or determining that the defined threshold amount of signaling is satisfied, determining that the aggressive user equipment detection analysis is to be performed, and
as part of the aggressive user equipment detection analysis, determining whether the attach request is a first attach request associated with the temporary user equipment identifier associated with the user equipment based on the result of the evaluating, wherein the result of the evaluating indicates whether the temporary user equipment identifier information comprises the temporary user equipment identifier, and wherein the temporary user equipment identifier information comprises the temporary user equipment identifiers associated with attach requests previously received by the network equipment.

16. The system of claim 15, wherein the operations further comprise:
in response to determining that the temporary user equipment identifier information does not comprise the temporary user equipment identifier, determining that the attach request is the first attach request associated with the temporary user equipment identifier;
declining the attach request;
storing the temporary user equipment identifier in the temporary user equipment identifier information associated with the network equipment to generate updated temporary user equipment identifier information; and
transmitting decline information to the user equipment, wherein the decline information indicates that the attach request has been declined.

17. The system of claim 15, wherein the result is a first result, and wherein the operations further comprise:
in response to determining that the temporary user equipment identifier information comprises the temporary user equipment identifier, determining that the attach request is not the first attach request associated with the temporary user equipment identifier that has been received by the network equipment, wherein a prior attach request associated with the temporary user equipment identifier had been received by the network equipment prior to the attach request, wherein the temporary user equipment identifier information comprises first time information that indicates a first time that the prior attach request was communicated by the user equipment, and wherein the attach request information comprises second time information that indicates a second time that the attach request was communicated by the user equipment; and
based on a second result of the evaluating, determining whether a length of time between the second time of a second communication of the attach request and the first time of a first communication of the previous attach request by the user equipment satisfies a defined length of time relating to communication of attach requests.

18. The system of claim 17, wherein the operations further comprise:
one of:
in response to determining that the length of time does not satisfy the defined length of time, determining that the user equipment is engaging in a defined aggressive action and the attach request is to be declined, and
transmitting decline information to the user equipment, wherein the decline information indicates that the attach request has been declined; or
in response to determining that the length of time satisfies the defined length of time, determining that the attach request is to be accepted, and
transmitting accept information to the user equipment, wherein the accept information indicates that the attach request has been accepted.

19. A non-transitory machine-readable medium, comprising executable instructions that, when executed by a processor, facilitate performance of operations, comprising:
analyzing registration request data and temporary device identifier data, wherein the registration request data relates to a registration request received from a device attempting to register to attach to network equipment, wherein the registration request data comprises a temporary device identifier that is associated with the device for a temporary and unknown length of time, and wherein the temporary device identifier data is associated with the network equipment and relates to temporary device identifiers associated with devices; and
based on the analyzing, determining whether to accept the registration request associated with the device.

20. The non-transitory machine-readable medium of claim 19, wherein the operations further comprise:
at least one of:
determining whether the registration request is a first registration request associated with the temporary device identifier based on a first result of the analyzing indicating whether the temporary device identifier data comprises the temporary device identifier; or
determining whether an amount of time between the device transmitting the registration request and transmitting a previous registration request associated with the temporary device identifier satisfies a defined threshold amount of time relating to transmission of registration requests based on a second result of the analyzing indicating the amount of time,
wherein the determining whether to accept the registration request associated with the device comprises determining whether to accept or reject the registration request associated with the device based on at least one of a third result of the determining of whether the registration request is the first registration request associated with the temporary device identifier or a fourth result of the determining of whether the amount of time satisfies the defined threshold amount of time.
